(19) United States
(12) Patent Application Publication
(10) Pub. No.: US 2026/0188134 A1
(43) Pub. Date: Jul. 2, 2026

(54) System and Method for Generating Course Content

(71) Applicant: 1206881 Alberta Ltd., Edmonton (CA)

(72) Inventors: Holly M. BRATTBERG, Canmore (CA); Stephen A WENZEL, Canmore (CA); Christopher CADIZ, Winnipeg (CA); Aarti GUPTA, Calgary (CA); Susan BRATTBERG, Edmonton (CA)

(73) Assignee: 1206881 Alberta Ltd., Edmonton, AB (CA)

(21) Appl. No.: 19/549,073

(22) Filed: Feb. 25, 2026

Related U.S. Application Data
(63) Continuation of application No. PCT/CA2024/051115, filed on Aug. 28, 2024.
(60) Provisional application No. 63/579,168, filed on Aug. 28, 2023.

(51) Int. Cl. G09B 7/00; G06F 40/166; G06F 40/58; G06Q 10/101; G09B 5/00

(52) U.S. Cl. CPC G09B 7/00; G06F 40/166; G06F 40/58; G06Q 10/101; G09B 5/00

(57) ABSTRACT

A system and method are provided for generating a course. The method includes obtaining answers to one or more questions pertaining to the course; using the answers to the one or more questions to generate a set of inputs; feeding the inputs to a large language model (LLM); receiving a response from the LLM providing a course outline; enabling content to be generated for at least one portion of the course outline; providing a second set of inputs to the LLM; and populating the at least one portion of the course outline using a response from the LLM.

### CROSS-REFERENCE TO RELATED APPLICATION(S)

This application is a Continuation of PCT Patent Application No. PCT/CA2024/051115 filed on Aug. 28, 2024, which claims priority to U.S. Provisional Patent Application No. 63/579,168 filed on Aug. 28, 2023, the contents of which are incorporated herein by reference in their entirety.

### TECHNICAL FIELD

The following generally relates to generating course content, including automated processes for same.

### BACKGROUND

Generating and publishing electronic content can be time consuming, particularly when the content is to be presented in a specific way in order to have a desired or otherwise beneficial effect. For example, content for electronic training (e-training) or electronic learning (e-learning) often required consideration of what type of content is included, in what order, and in what fashion. Typically, this is a manual process based on inputs from a client or customer, previous experience, and previous work.

### SUMMARY

In one aspect, there is provided a computer-implemented method of generating electronic content, comprising: obtaining, via a first user interface element, a first set of inputs responsive to one or more questions associated with an electronic course being authored; using the first set of inputs to generate a first prompt to instruct a large language model (LLM) to generate a course outline; providing the first prompt to the LLM; receiving a first response from the LLM providing the course outline generated by the LLM based on the first set of inputs; providing a second user interface element presenting at least one portion of the course outline; enabling content to be generated for the at least one portion of the course outline, by generating at least one second prompt from the course outline or information associated with the at least one portion of the course outline; providing the second prompt to an LLM; and populating the at least one portion of the course outline using at least one second response from the LLM.

In example embodiments, an LLM is prompted a plurality of times, each time corresponding to a portion of the course outline to populate a plurality of course sections, chapters or slides.

In example embodiments, the method further includes enabling content added to the course to be edited.

In example embodiments, enabling the content added to the course to be edited comprises a further prompt to an LLM to refine the content.

In example embodiments, the method further includes publishing the course based on a final course outline and content added to each portion of the course outline.

In example embodiments, the method further includes storing the course in a centralized location; permitting a plurality of learning management systems (LMSs) to access the course; and responsive to a change or addition to the course recorded at the centralized location, pushing out updates to the plurality of LMSs to automatically synchronize content across all instances of the course.

In example embodiments, at least one of the first and second user interface elements is displayed responsive to an artificial intelligence option presented in a course generator application provided by a cloud-based course generator system.

In example embodiments, the method further includes providing a translation module to translate content to be added to the course to be translated to a desired language.

In example embodiments, the method further includes detecting that a first content object being added to the course is authored in a second language to be translated to a first language used by the course; determining if the first content object is itself a translation of a second content object; responsive to determining that the first content object is itself a translation, obtaining the second content object and utilizing it if using the first language or translating it from a third language to the first language.

In example embodiments, content objects previously used are stored with pointers or links thereto to create a network of available content objects to ensure objects are translated only a single time from an authored language.

In example embodiments, the method further includes tracking rights to content objects to apply licensing remuneration.

In example embodiments, the method further includes determining all translations required to populate the course in a desired language and prompting a user for payment of translation fees prior to publishing.

In example embodiments, the method further includes enabling collaboration by a plurality of users in generating and adding content to the course, and performing version control to avoid collisions.

In example embodiments, content is wrapped as a shareable content object (SCO) to enable hierarchical relationships, versioning, translation, and dynamic updates to the content on multiple learning management systems.

In example embodiments, the SCO is configured to enable reverse flow of data from the multiple learning management systems back to the system in a plurality of discrete data chunks.

In example embodiments, the discrete data chunks are lined up across the multiple learning management systems to enable aggregate data and information compiling when such multiple systems are not inherently built to align.

In another aspect, there is provided a computer readable medium comprising computer-executable instructions for generating electronic content, comprising instructions that, when executed by a processor of a computing system, cause the computing system to perform the method and example embodiments as described above.

In another aspect, there is provided a computing system for generating electronic content, the system comprising at least one processor and at least one memory, the memory storing computer executable instructions that, when executed by the at least one processor, cause the computing system to perform the method and example embodiments as described above.

### BRIEF DESCRIPTION OF THE DRAWINGS

Embodiments will now be described with reference to the appended drawings wherein:

FIG. 1 is a block diagram of an example of a cloud-based course generator system for generating and publishing electronic content.

FIG. 2a is a block diagram of an example of a configuration for the course generator system.

FIG. 2b is a block diagram of an example of a client device.

FIG. 3 is a flow chart illustrating a processing flow for incorporating multiple types of media files into a published output and for wrapping data into sharable content objects (SCOs).

FIG. 4 is a flow chart illustrating operations performed in utilizing a large language model (LLM) to auto-generate at least some content for a course.

FIGS. 5a to 5g illustrate building a course using AI generation options.

FIG. 6 illustrates an example of an AI-generated course outline.

FIG. 7 illustrates an AI generation input question.

FIG. 8a illustrates a response to the input question in FIG. 7.

FIG. 8b illustrates an AI option for automatically generating content for a topic within a course outline.

FIG. 9 illustrates an auto-generated set of options for content based on a topic description or title.

FIG. 10 illustrates auto-generated content for a slide in a course.

FIGS. 11a and 11b illustrate a referential system for managing languages and translations of content items being added to a slide in a course.

FIG. 12a illustrates a translation workflow for translating course content.

FIG. 12b is a flow chart illustrating operations in creating a new course based on a language selection.

FIG. 13 illustrates a skills gap assessment tool.

FIG. 14 illustrates a progress page.

FIG. 15 illustrates an example of a course page.

FIG. 16 illustrates a quiz generation page.

FIG. 17 illustrates a custom learning path and insights page.

FIG. 18 illustrates a custom learning path page as seen by a user.

FIG. 19 illustrates a quiz report page.

FIG. 20 illustrates a tagging option in a quiz generation page.

FIG. 21 illustrates a tagging window.

FIG. 22 illustrates an exam to course mapping.

FIG. 23 illustrates a notify option in a progress page for sending progress updates.

FIG. 24 illustrates a notification history page.

FIG. 25 illustrates a progress report message.

FIG. 26 illustrates an exam results output.

FIG. 27 illustrates a learners versus score graph.

FIG. 28 illustrates learners versus custom learning patent (CLP) progress.

FIG. 29 illustrates a learner results output.

FIG. 30 illustrates a quiz name versus score graph.

FIG. 31 illustrates a quiz versus CLP completion graph.

FIGS. 32a, 32b, and 32c are a flow chart illustrating operations performed in a licensing model workflow.

### DETAILED DESCRIPTION

### Course Generator System

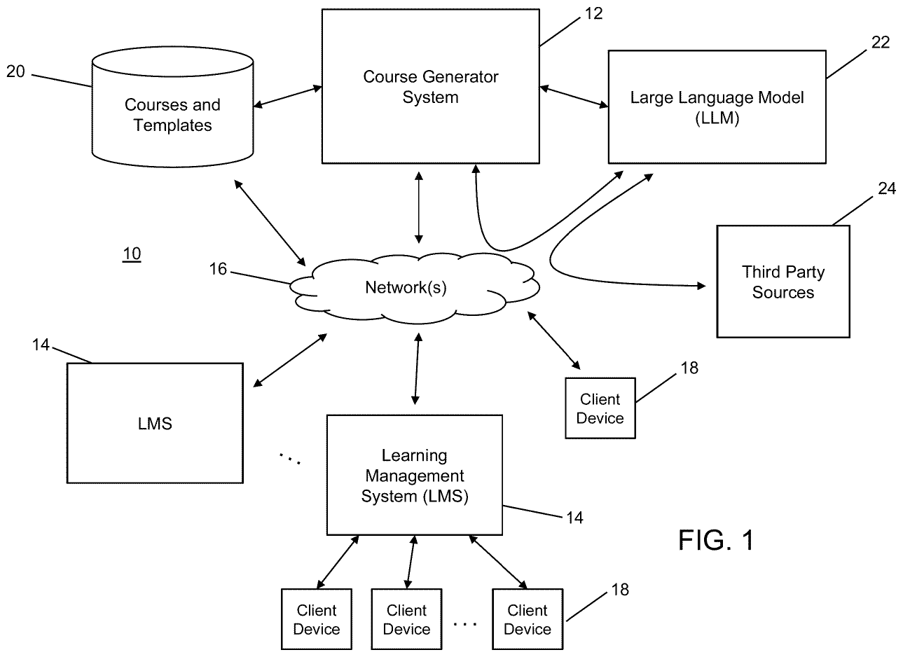

Referring now to the figures, a course generator system 12 is shown in FIG. 1, which provides a computing platform or computing environment 10, e.g., a cloud-based computing platform of one or more computing servers, for users to generate content, either individually or directly, or via access provided by a learning management system (LMS) connectable to the course generator system 14. In this example, the course generator system 12 is coupled to one or more networks 16 to enable an LMS 14 and/or client devices 18 to access and utilize the system 12. It can be appreciated that multiple LMSs 14 and client devices 18 can access the course generator system 12 via the network(s) 16 (as shown), and the particular configuration shown in FIG. 1 is illustrative only.

The course generator system 12 generates courses and may utilize templates for creating such courses, which may be stored in a courses and templates storage device 20. It can be appreciated that the storage device 20 is shown separately from the course generator system 12 for ease of illustration and to indicate that the storage device 20 may be directly or indirectly accessible to the LMSs 14 and client devices 18. The course generator system 12 also includes or has access to a large language model (LLM) 22 or other available machine learning (ML)-based model that can be utilized to automate at least one process used in generating a course, template, content, etc. as described herein. That is, to address the technical challenges associated with authoring, arranging and compiling content, the LLM 22 may be leveraged by the system 12 to not only automate the authoring, compiling and publishing processes, but to overcome various technical challenges associated with obtaining, formatting, scaling, storing, streaming, editing and performing various other multi-media operations that would otherwise be slow and inefficient in a manual publishing environment. The LLM 22 and/or the course generator system 12 may access third party sources 24. For example, the LLM 22 may find or determine content by accessing publicly available content over the internet by utilizing communication and data transfer interfaces between entities shown herein.

The network 16 shown in FIG. 1 is a network 16 such as a wired and/or a wireless communication system, for example, an Internet-based network accessible or otherwise used by the system 12. The network 16 can include a communications network such as a telephone network, cellular, and/or data communication network to connect different types of communication devices. For example, the network 16 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

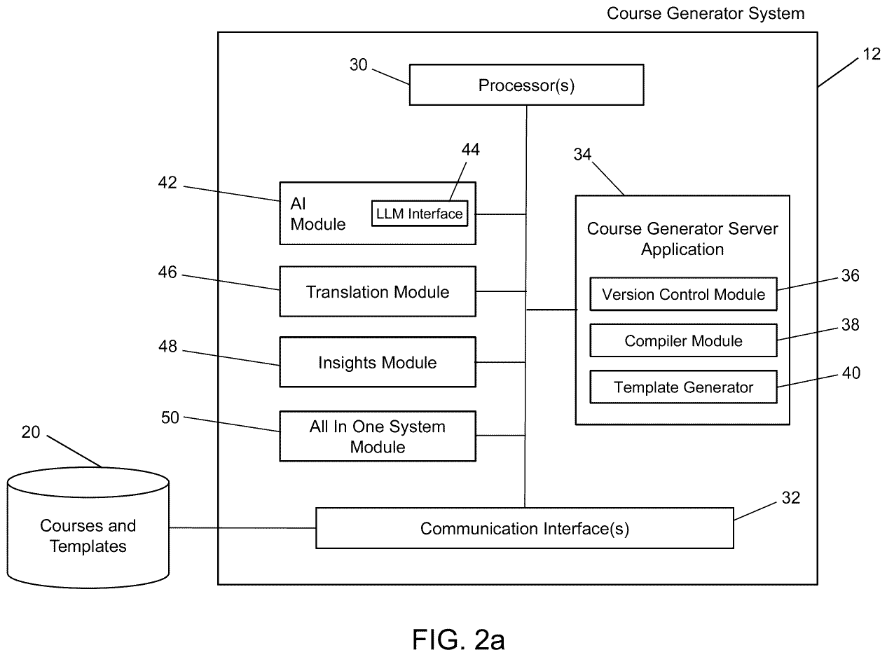

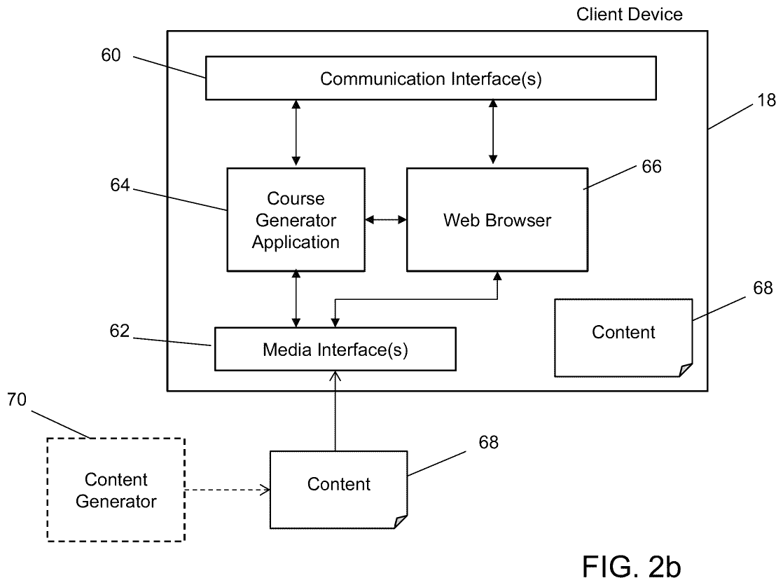

FIG. 2a provides an example configuration for the course generator system 12. In certain embodiments, the system 12 may include one or more processors 30, and one or more communication interfaces 32, which may include interfaces to communicate with external networks, media, content, storage devices, computing devices, etc. Communication interfaces 32 enable the system 12 to communicate with one or more other components of the computing environment 10, such as client devices 18 (or one of its components) or LMSs 14 (or one of its components), via a bus or other communication network, such as the communication network 16. While not delineated in FIG. 2a, the system 12 includes at least one memory or memory device that can include a tangible and non-transitory computer-readable medium having stored therein computer programs, sets of instructions, code, or data to be executed by processor 30. FIG. 2a illustrates examples of modules, tools and engines stored in memory on the system 12 and operated by the processor 30. It can be appreciated that any of the modules, tools, and engines shown in FIG. 2 may also be hosted externally and be available to the system 12, e.g., via a communication interface 32. Similarly, the courses and templates data storage 20 may be hosted externally as shown, or internally (not shown).

In the example embodiment shown in FIG. 2a, the system 12 includes a course generator server application 34 that can be accessed by client devices 18, e.g., via a course generator application 64 and/or web browser 66 (see FIG. 2b described below). The server application 34 in this example configuration includes a version control module 36 to control versioning of courses accessed by multiple entities, a compiler module 38 to compile and publish courses, and a template generator 40 to enable users or organizations to generate templates for course generation, e.g., as described in U.S. Pat. No. 11,714,958, the contents of which are incorporated herein by reference in their entirety. The system 12 in this example also includes an artificial intelligence (AI) module 42 to allow content creators to leverage ML and other AI-related tools to more rapidly and efficiently generate, refine, update, and publish content for courses. For example, the AI module 42 may include a LLM interface 44, such as an application programming interface (API) or other application-to-application gateway, to allow the AI module 42 to leverage the abilities of the LLM 22 in generating course content for the course generator server application 34, among other things. The LLM interface 44 may be configured to enable the system 12 to select from different LLMs 22 and/or different ML-based models where appropriate, to leverage specific information based on the type of course being generated. The system 12 also may include a translation module 46 to generate translated content for course materials, an insights module 48 to enable organizations to chart and evaluate the results of courses, quizzes, etc.; and an all in one system (AIOS) module 50 to allow for user management, course management, and data management pertaining to training.

FIG. 2b illustrates an example of a configuration for a client device 18. The client device 18 includes one or more communication interfaces 60 to enable the client device 18 to connect to the system 12 (and/or storage device 20) via the one or more networks 16. The client device 18 also includes a course generator application 64. The application 64 can include or have access to content generation tools, for example, a text editor or word processor, camera, video editing, etc. Also shown is a web browser 66 that may be used to access a web-based application similar to the application 64 or other content available via the internet, e.g., by accessing a secure website. As shown, content 68 can be generated and/or accessible from on the client device 18 or can be loaded into the client device 18, e.g., via a media interface 62. Also, an external content generator 70 (e.g., camera, other computer) can be used to generate such content 68. While not shown in FIG. 2b for ease of illustration, it can be appreciated that the client device 18 may be embodied using any suitable computing device such as a smartphone, tablet or laptop or desktop computer or customized computing device, which would include one or more processors and at least one memory or memory device that can include a tangible and non-transitory computer-readable medium having stored therein computer programs, sets of instructions, code, or data to be executed by such processor.

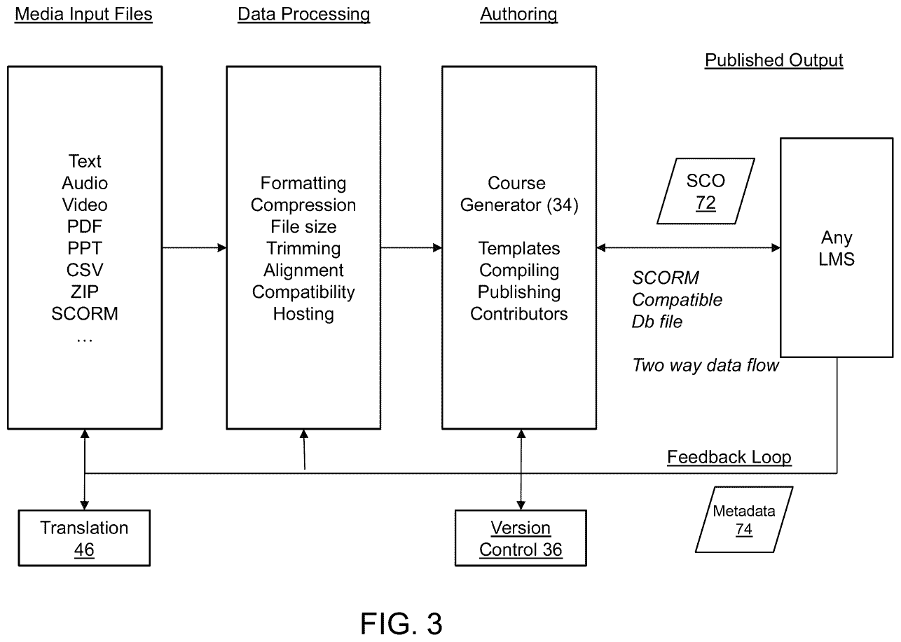

FIG. 3 illustrates a process flow that enables the processing and compilation of various media input file types for published outputs, including the wrapping of content into shareable content objects (SCOs) 72, further details of which are provided below. As shown in FIG. 3, various media input file types can be handled by the system 12, for example, without limitation, text, audio, video, PDF, PowerPoint (PPT), comma-separated value (CSV), compressed (e.g., ZIP), shareable content object reference model (SCORM), etc. These various input file types may be subjected to translation, where necessary, as described herein, e.g., using the translation module 46. A data processing stage may then be applied to ensure consistent and compatible formatting, compression, file size, trimming, alignment, compatibility, hosting, etc. This enables data objects to be utilized by the system 12 as described herein, for example to utilize templates, enable compiling and publishing of courses, and allow for consistent and compatible contribution by multiple users. The course generator application 34 may then generate SCOs 72 that are SCORM compatible to enable them to be used with any LMS 14 and to enable two-way data flow with the LMSs 14. Also shown in FIG. 3 is a feedback loop that allows changes to templates and courses made from such templates to be captured at metadata 74 and be fed back to the processing flow to enable changes to be centrally stored and pushed out to other users and courses that have relied upon or otherwise utilized that content. For example, if a blurb of text is edited and updates saved to the system 12, the system 12 may push out the edits to any other courses that have used the same blurb (e.g., using the drag and drop methods described later). It can be appreciated that whether AI is used to author content or that content is authored manually or incorporated from elsewhere, the published output process of the course generator 34, hosting on any LMS 14, ongoing updates and feedback plus metadata feedback 74 remains consistent.

### SCOs and Environment-Agnostic Remote Access of SCOs

The SCOs 72 enable parent, child, grandparent relationship, versioning, translation and all dynamic updates to the content on multiple LMSs 14. File size of the SCO 72 is greatly reduced compared to a SCORM file which is uploaded manually to each LMS 14 and must be updated in each instance, each time. The SCOs 72 also enable reverse flow of data from multiple LMS systems 14 back to content generator 34 in bite sized chunks. This granular data is then ‘lined up’ across multiple/all LMS systems 14 to enable aggregate data and information compiling when multiple systems are not built to align.

SCOs 72 generated in an e-learning course such as that described herein can create certain challenges, in particular when communicating such objects to third-party controlled file systems or endpoints, e.g., any LMS 14. It was found that once uploaded to such an endpoint, solutions are lacking to reliably update, regulate access to, or collect telemetry from the SCOs 72 in these circumstances. Moreover, while loose standards exist regarding the structure of SCOs 72, such standards were found to be unstructured with a wide variety in the variation in the content interpretation/parsing logic used by endpoints that severely constrains the system's ability to utilize an ednpoint-agnostic file structure and set of communication methods. The SCOs 72 utilized herein address these and other challenges as described below.

The system 12 is configured to utilize techniques to update the content of- and manage access to-data stored on third-party LMS systems 14, which requires a robust telemetry and state-tracking system. To address this, a single data representation capable of representing an arbitrary sequence of multimedia using an XML-based encoding scheme was developed, and used to embed streaming machinery within a SCO 72 without unacceptable communications and authentication issues. A number of unpredictable, adverse interactions arising from mutually conflicting limitations imposed by the target endpoints were encountered, notably with respect to the structure and packaging of data and instructions, file size/bandwidth limitations, and data parsing and rendering issues. These issues are exacerbated by the fact that there is typically no direct control over the environment in which the data is hosted and presented. As a result, a file structure and communication system were needed that are capable of delivering and visualizing arbitrary SCO-embedded multimedia content independently of client-side software environment used to access, render, and interact with this information.

The system 12 was developed to include a highly flexible method to structure data to accommodate a wide variety of sequences and representation structures, as well as to address issues arising from the fact that each endpoint has its own distinct methods of parsing SCOs 72. This includes the consideration of lightweight data compression and encoding methods, as well as techniques for embedding streaming software within the constraints of SCOs 72. It is recognized that, in some cases, issues pertaining to limitations on the number of data objects that can be encapsulated in any one content package may be encountered. These limits may be address via the use of a hierarchical data structure, however, this could conflict with endpoints' parsing systems.

Additionally or alternatively, a method to expand the capabilities of the above streaming system, alongside a set of related software techniques to allow dynamic retrieval and presentation of content independent of the browser, document, container, or client-side software environment used for rendering and interaction may be employed. A technique for embedding streaming machinery within these SCOs 72, as updates to content may render existing state-tracking obsolete and, as such techniques to track and present the appropriate version may also be incorporated. Specifically, a method to infer the nature of an update as (i.e. destructive or non-destructive), and appropriately invalidate content can be employed. Moreover, to overcome limitations in authentication and connection management as well as in the tracking of sessions and the collection of telemetry data, the system 12 employs a bidirectional communication system to allow the interface described above to identify agents that were accessing this data and compute appropriate responses (as required to continue sessions, manage permissions, and track and respond to events and requests).

It has been found that in collecting and communicating events (e.g. inputs, timing information) arising from conflicting parsing logic or channel-management requirements between endpoints issues may be encountered, for example, in suspending or terminating a session without experiencing data loss due to the indirect nature of our interface with the individuals inputting data, in identifying the identity of individuals attempting to access our data through this proxy system, and the parsing of a variety of other metadata. To address this, a technique may be employed which utilizes a large number of extremely lightweight and granular updates, which can improve overall accuracy by ensuring that failures by third-party parsing and aggregation systems would have a smaller impact on accuracy and cause fewer artifacts.

Accordingly, new techniques were identified to render data multimedia objects independent of the browser, document, container, or environment that the software is operating within. Specifically, methods for embedding streaming software within a SCO file 72 to be hosted on a third-party controlled system and overcoming the subsequent session management and authentication obstacles. Methods may also be employed to ensure that the above data is reliably rendered, and to ensure that interactions the events are appropriately processed despite variations in the container or context used to visualize this information. This may require bidirectional communication methods and highly robust event and metadata parsing techniques to ensure that telemetry can be captured, stored, and processed, regardless of the properties of the endpoint used to access the content.

The system 12 therefore incorporates environment-agnostic techniques for streaming SCO-data that addresses challenges with tracking and presentation of data due to issues with parsing and unpacking of hierarchical objects. These issues may inhibit the system 12 from operating when rendered on external endpoints and may inhibit these endpoints from parsing tracking data when rendered locally.

It was postulated that an xAPI-based communication system and endpoint-agnostic message-bus, however conventional record stores may be incapable of tracking many of the kinds of event data required by the system 12, due data formatting requirements that severely constrained the format and type of data can be communicated, notably with regard to timing information. Additionally, API statements by the system 12 may end up returning tracking data at a high granularity, (i.e. based on a large number of child-objects which separately retrieve and communicate telemetry data). However, due to the above-described obstacles in resolving the structure of the object hierarchy, the data retrieved was unable to relate the tracked-events to source objects/components. To address this, software methods for improved mapping of child objects to categorical/topical obest were developed for the purposes of analysis. A method was then postulated for manipulating the parsing and grouping logic of endpoint unpacking systems, which would allow a single file to be uploaded by the system 12, and split on the receiving end into separately tracked objects. To address scalability challenges (in that a large hierarchy would require dozens or hundreds of separate encoding and uploading operations), a method was developed to identify, group, and wrap the SCOs 72 such that endpoints would unwind the hierarchy into the correct structure during processing.

To address potential adverse interactions between the target endpoints and the large numbers of individual data stores involved in the organization and distribution of our content, which was observed by experimentally reseeding a database with a limited number of data sources, it was found that a conflict may arise from a constraint in message protocols limited in the volume of addressing data it was able to pass to endpoints. To address this challenge, the messaging system was configured as described herein to reduce the overhead required to communicate meta information and addresses. A data model was developed that can successfully package and manage this data with further considerations to support the filtering and analysis.

In addition, the system 12 can provide a capability to version and share components/content of the encoded SCOs 72, both to allow multiple separate SCOs 72 to share a single piece of content, as well as to allow automatic translation of a single piece of content into multiple languages while allowing these translated outputs to update themselves in response to changes to the master/source. As updates to content necessarily impact existing state-tracking, and as the system 12 may be configured to allow rejection of updates on a piecemeal basis, to address obstacles related to the deletion of dependencies, the system 12 may use a method to infer the nature of an update as (i.e. destructive or non-destructive) and allow the merging of changes, even where intermediate updates to the source were rejected/ignored. This drafting system can limit the scope of branches within these contents, and for handling direct, live references which draw from the same source data separately from indirect ones which require a publishing step.

Translation may present an obstacle in that the layout/timing and presentation of data changes when converted between languages. Conventional systems (e.g. PDF) are incapable of dynamically restructuring information, and as such improved methods for representing and positioning information within a document were developed. This was especially problematic in the case of synchronizing closed captions of audio and video information to the timing of the source speech.

Moreover, the system 12 may be configured to manage bandwidth associated with uploading, tracking, and processing large volumes of data to multiple endpoints.

To ensure that the above data is reliably rendered, and to ensure that interactions the events are appropriately processed despite variations in the container or context used to visualize this information, the system 12 adopts bidirectional communication methods and highly robust event and metadata parsing techniques to ensure that telemetry can be captured, stored, and processed, regardless of the properties of the endpoint used to access our content. The system 12 may also utilize techniques to render data multimedia objects independent of the browser, document, container, or environment that said software is operating within. Specifically, methods for embedding streaming software within a SCO file 72 to be hosted on a third-party controlled system and overcoming the subsequent session management and authentication obstacles.

To inject multimedia data into a range of endpoints possessing mutually incompatible representation and communications mechanisms can give rise to unpredictable, adverse interactions between the system's own injection software, and the SCO sources being encoded and injected to endpoints (which are outside of the system's scope of control). These issues may not be capable of being resolved by conditional techniques and presents technological uncertainty regarding consistent SCO delivery via this injection pipeline regardless of the content of the source SCO 72, or the behavior of the various presentation endpoints regard to parsing, structuring, and rendering, which may be mutually incompatible and so prohibits static or otherwise conventional data-structuring methods. The system 12 may thus aim to use communication methods capable of delivering arbitrary, SCO-embedded data and instructions to these endpoints.

The system 12 encapsulates telemetry data obtained from endpoint-SCO module interactions, which serves as a feedback mechanism that informs a decisioning subsystem to control subsequent actions (i.e. as individual modules within a SCO may require specific objectives and data fields). The encapsulation system can be configured to ensure that linkages between discrete content elements be maintained (i.e. sub-SCO level data/software from which interaction telemetry is acquired). The system 12 should be configured to handle event sampling and data encapsulation techniques that prevent adverse interactions between the mappings occurring between discrete content elements as managed by various data hosts, in order to maintain consistency in the rendering of the data streams.

Mechanisms used by third-party management systems to communicate with endpoints may possess mutually incompatible representations and communications mechanisms to transport distinct types of data (e.g. SCOs 72, progress indicators, etc.). Common techniques to track binary interaction outcomes (e.g. multiple-choice questions) tracked by each endpoint data rendering system were identified and the system 12 may be configured for a generic progress-tracking technique capable of handling arbitrary multimedia and SCO-encoded object hierarchies. Designing conditional logic or branching techniques to handle the entire range of cases identified may be infeasible and highly sensitive to unforeseen conditions. To resolve this problem, a general-case method may be used which enforces a separation of concerns between progress-funneling actions and telemetry acquisition operations. This can improve the system's ability to deal with the variation between the data-unpacking and parsing logic across endpoint data parsing and administration systems, and by improving software for manipulating the parsing and grouping-logic of endpoint unpacking systems so as to maintain consistency while sharing arbitrary data objects with an endpoint.

Subsequent testing revealed fine-grained, data-object mapping inconsistencies between discrete elements at the object level (e.g. upon handling multiple transformations embedded within a single document) as managed and rendered by distinct endpoints, which can cause issues where the inheritance structure of the data being processed became compromised, while attempting to generate language translations whose root differed from the master/source copy.

It was also found that modifications to the mechanism employed to encode or decode SCO data at either end of the information delivery pipeline (outside of the system's scope of control) manifested as broken xAPI dependencies leading to data processing aberrations at the presentation/abstraction layer due to the hierarchical nature of the content being handled. Furthermore, a subsequent analysis revealed that a time-tracking mechanism can be intertwined with the process execution thread of the host window/tab of the browser, and that any action enforced onto the corresponding container can have an adverse effect on the time-tracking capabilities of the system's mechanism. To resolve this problem, a process isolation technique may be used to separate/seclude the time-tracking algorithm. It was determined that fine-grained time-tracking capability can become somewhat limited as compared to prior iterations due to unresolved inter-process conflicts with the corresponding web browser. However, it was determined that results remained acceptable, as time-tracking granularity remained above a critical threshold.

The system 12 may also adopt methods to deliver data authored and packaged by third-party tools, which would otherwise cause adverse interactions with the system's own data wrapper. A data-object encapsulation approach may be used that enables the system 12 to bypass the encapsulation employed by a subset of the objects being streamed, which can prevent the system 12 from gaining control over specific data elements. This issue may be addressed by a modular pipeline design that employs branching logic to identify the variables present (i.e. endpoint type, web browser, SCORM specification, etc.) so as to determine which interfaces should be referenced to access specific elements and to track more granular interactions. Telemetry acquisition problems may also be encountered, given that the external data administration systems may not receive data as expected, for which is proposed employing a shim layer to intercept and manage/wrap data with our codes before being forwarded. To provide a capability to read SCOs 72, the system 12 may adopt a new software method to interpret SCO data (i.e. telemetry), and to translate it into a format that was compatible with the proprietary system 12. This approach can enable the system 12 to send SCO objects in a way that can be seamlessly interpreted by the corresponding endpoint.

To address potential time-tracking issues that may be traced to disparate data formatting requirements which can constrain the type of child-objects capable of communicating telemetry information, telemetry data may be sent by referencing divergent encoding conventions depending on the communications mechanism being employed. To enable this to occur in a genericized approach, a branching-logic technique capable of resolving object hierarchy dependencies to track telemetry at a granular level, and that is compatible with most telemetry communications conventions may be utilized.

Mechanisms employed to encapsulate progress/interaction telemetry as enabled by time-tracking primitives available by third-party content authoring tools were considered. It has been determined that for some of the objects being presented, data encoding is rather static and does not allow time-based progress tracking or audio embedding. In addition, some of the object-creation tools encode data in a way which is incompatible with the present data streaming system, leading to broken mapping with specific content elements (granular, 1:1 correlation is lost). To resolve this issue, a candidate technique can be used that enables audio embedding and splicing, which we believe we will be able to stream into an arbitrary presentation frame in a manner that is compatible with all forms of external endpoints without requiring additional provisions.

The system 12 can therefore employ methods for delivering arbitrary SCO-encoded data, and to enable seamless telemetry tracking and analysis with this information independently of time-invariable, client-side environment version updates. To this end, techniques may be used that enable an ability to measure regardless of arbitrary modifications at either end of the content delivery pipeline. Notably, a technique can be used that enforces a separation of concerns between progress funneling actions and telemetry acquisition operations by manipulating the parsing and grouping logic of endpoint unpacking systems so as to maintain consistency while sharing arbitrary data objects between SCO relational models and an endpoint. In addition, the system 12 can be configured to resolve timing-tracking problems, and to deliver data authored by third-party tools, which had been wrapped by SCO code that was incompatible with our proposed information delivery system. These approaches may be capable of supporting more than 60 different endpoint systems and up to 3 different web browser technologies, in example implementations.

The system 12 may also adopt software to ensure that the event and telemetry data generated by these objects was received and processed accurately by both the system 12 and the hosting environment (e.g., any LMS 14). Specifically, telemetry analysis methods may be used that are resilient to adverse interactions between the mappings occurring between discrete content elements as managed by an endpoint. This may be further configured to enable audio embedding and splicing currently unsupported by static methods for data representation, and to provide a wider endpoint coverage.

With respect to environment-agnostic techniques for streaming SCO-data certain data acquisition obstacles were observed that could cause data loss during session termination, which can be exacerbated by the fact that intermittent and non-reproducible inconsistencies may be observed when executing API fetch operations with these remote endpoints. While reducing transmission overhead may be attempted by modifying the data-generation systems involved in the telemetry system, sufficient reduction/compression may not be possible without unacceptable loss to the ability to provide data descriptiveness. An alternative method and early-commit process may instead be used, whereby it is postulated that modification introduced at the session loading phase of the telemetry-logic could allow the system 12 to perform granular data deliveries across the whole session duration, instead of populating them all at once during session termination, and thereby reducing object-lifecycle management issues related to interference and inconsistent behaviours exhibited by browsers during the termination phase of a session.

To this end, a content handling mechanism can be employed that dispatches session data and events into dedicated stage chunks to represent specific phases (initiation, loading, closing, etc.) and asynchronously commit them to the network as they arrive. The discontinuous aspect of this mechanism may, in some implementations be incompatible with certain specific data objects constrained to a scheduling related completion paradigm (i.e., real-time evaluation results/quizzes need a wait for completion mechanism throughout the whole session prior to committing). To address this, the system 12 can be configured to attach data objects to relevant stage chunks, and compute the corresponding encapsulation logic at each phase. This can allow the system 12 to increase transmission frequency with little impact on bandwidth consumption.

The system 12 may also employ methods to deliver arbitrary SCO data, which can otherwise cause telemetry transmission problems. While one could compute correlated data properties at the acquisition layer (i.e. process SCORM score based on SCORM response) and send only compliant data objects, this may require a redeployment of existing data repositories, which could disrupt data versioning. To resolve this issue, a software method was developed for the system 12 to dynamically encapsulate SCO data (i.e. telemetry) by overriding the static interpretation logic at the instantiation level. The method loads an existing static logic from the system, then applies additional computation algorithms to modify the logic's behavior. A switching algorithm may be used that executes a dedicated process (either computing and sending only the SCORM score or the SCORM response) depending on the presence or absence of a special character in data objects.

The system 12 may also be configured to have the capability to version and share components/content of the encoded SCOs 72, both to allow multiple separate SCOs 72 to share a single piece of content while allowing outputs to update themselves in response to changes to the master/source. While a method to utilize a hierarchy of references to achieve this, it may cause node synchronization and orphaning issues upon deletion of source data, and overheads with managing highly branched reference trees with arbitrary complexity. To address these obstacles, the system 12 may use a method to allow the merging of changes, even where intermediate updates to the source were rejected/ignored. A drafting system can be used which limits the scope of branches within these contents, and handles direct, live references which draw from the same source data separately from indirect ones which require a publishing step. Other issues may be encountered such as conflicts with the pointer/referencing system used to retrieve and present content. A dual caching mechanism may be used that stores both the published and progress version of data objects, allowing ad-hoc computation of a diff of the edited content. A supplementary deletion checking can be encapsulated and abstracted for each content type (e.g. in the e-learning context, we may have presentation slides, videos, interactive quizzes, etc.). Additional data syncing constraints may be introduced on the data configuration/generation side, as part of that logic is abstracted away for each content type, however, content can also be edited from within the corresponding data object.

As such, the system 12 can be configured for delivering arbitrary SCO-encoded data, and to enable seamless telemetry-collection and analysis with this information independently of time-invariable, client-side environment version updates. To this end, techniques can be employed that enable data acquisition/manipulation regardless of arbitrary modifications at either end of the content delivery pipeline. Notably, a content handling mechanism may be used that dispatches session data and events into dedicated stage chunks that represent specific phases, attach data objects to relevant chunks, compute the corresponding encapsulation logic at each phase and asynchronously commit them to the network in an iterative process. In addition, techniques to deliver arbitrary data authored and packaged by third-party tools with the objective to support special Unicode language scripts and characters can be utilized by the system 12.

Techniques may also be employed to compute diffs and version data objects independent of the browser, document, container, or environment generating these data. Specifically, a dual caching mechanism can be used, which stores both the published and progress version of data objects, allowing diff computation of modifications affecting the edited content. The mechanism assures data tracking in a branching hierarchy by measuring the distance between each changeset of data object and subsequently applies a deletion and node integrity verification algorithm that is encapsulated and abstracted for each type of content type (Slide, Video, Quiz). This can improve the system's ability to achieve piecemeal and incremental updating of these SCOs, especially as it pertains to context-dependent application of updates to content.

It has also been found that the injection of SCO data into a range of disparate endpoints can present obstacles in that additional constraints enforced by third-party controlled data sources (e.g. data synchronisation/duplication between individual LMSs 14) would have counterproductive effects on the system's integration designs patterns. Notably, the acquisition layer is composed of independent LMSs 14 that individually encapsulate the ingestion logic for input data (e.g. evaluation score, course evolution, etc.), resulting in siloed environments that generate unpredictable, adverse interactions between our own injection software, and the SCO sources being encode and injected to. These issues present technological uncertainties regarding the design of a mechanism that achieves consistent SCO delivery regardless of the content or the behavior of the source/presentation SCO 72 in regard to parsing, structuring, and rendering. For example, one should consider encapsulation and communication methods capable of delivering arbitrary, SCO-embedded data and instructions to these endpoints.

Encapsulation of SCO objects can also present challenges to seamlessly track and update nested/entangled data objects, due to the fact that SCOs impose complex interdependence, integrity and synchronisation requirements with regard to inheritance, translation, and management of data objects, which may interfere with the branching hierarchy of the SCO data management process. For example, one should consider versioning methods for data objects with arbitrarily complex inheritance and/or translation relationships that could prevent adverse interactions between the mappings occurring between discrete content elements as managed by various data hosts, in order to maintain consistency in the rendering of our data streams.

In implementing the system 12, limitations at the data ingestion layer were encountered that were causing data/session association mismatch during instance/session mappings, wherein authored data (i.e. data received and compiled from LMS systems 14) would be inadvertently routed to the incorrect sub-processing instances on server-side. This can be exacerbated by the fact that intermittent and non-reproducible inconsistencies were observed when executing API fetch operations with these remote endpoints. Methods may be employed to reduce mapping inconsistencies by modifying the data-generation systems involved in the telemetry system for tracking and versioning author attributes from incoming data. To this end, a mechanism may be used for dynamic in-software access to specific instance data, which dynamically computes associative links at a more granular level (i.e. topics, course, questions, etc.) between each learning item and the corresponding profile accessing it. If faced with conflicts with the pointer/referencing system used to retrieve and present content, especially when these references are nested or when objects in the source SCO are reordered without explicit change to the child objects themselves, the system 12 may use modulation techniques to deliver data authored and packaged by third-party tools in a centralized environment (i.e. dynamically route/assign telemetry data to server instances for processing). A data-object aggregation approach can be used that enables the system 12 to bypass the encapsulation employed by a subset of the objects being streamed, which could prevent the system 12 from gaining control over specific data elements.

More specifically, a modular pipeline design can be employed that utilises a programmatic branching technique (i.e. sequentially/dynamically iterating through individual interacting LMS instances) to identify the variables present (i.e. endpoint type, web browser, SCORM specification, etc.) so as to determine which interfaces should be referenced to access specific elements and to track more granular interactions. In testing, additional limitations were discovered given that the external data administration systems were not receiving data as expected, for which the system may employ a shim layer to intercept and manage/wrap data with the system's code before being forwarded, which may improve data ingestion into third-party data systems and enable the generator 34 to send SCO objects 72 in a way that can be seamlessly interpreted by the corresponding endpoint. To enable the content generator 34 to read SCOs 72, a new software method may be used to interpret SCO data (i.e. telemetry), and to translate it into a format that was compatible with the proprietary system 12. The system 12 can therefore be configured for multiple endpoint SCO-streaming that is robust to inconsistencies (i.e. timing, file types, etc.) that arise between different SCORM systems.

It was also desirable to provide a capability to version and share components/content of the encoded SCOs 72, both to allow multiple separate SCOs 72 to share a single piece of content, as well as to allow automatic 1:n (i.e. one to many) mappings between a single piece of content and multiple target objects, as to provide dynamic updates response to changes to the master/source (e.g. such as procedural updates to multi-language translations).

To resolve these versioning/time-tracking problems that can be traced to disparate data formatting requirements which severely constrained the type of child-objects capable of communicating telemetry information (i.e. telemetry data was sent by referencing divergent encoding conventions depending on the communications mechanism being employed, which limited the concurrency capabilities of any genericized approach), a branching-logic technique can be used that is capable of resolving object hierarchy dependencies to track telemetry data at a granular level, and that was compatible with most telemetry communications conventions.

Additionally, alternative mechanisms were developed to encapsulate progress/interaction telemetry as enabled by time-tracking primitives available by third-party content authoring tools. Certain obstacles may be encountered in that for some of the objects being presented, statically encoded data structures do not allow time-based progress tracking. In addition, some of the object-creation tools encode data in a way that is incompatible with the present data streaming system, leading to broken mapping with specific content elements (granular, 1:1 correlation is lost). To resolve this issue, a technique may be employed that enables video embedding and splicing, which we believe will be able to stream into an arbitrary presentation frame in a manner that is compatible with all forms of external endpoints without requiring additional provisions. The proposed technique for remote-process manipulation and telemetry collection can be used to allow high-resolution data collection and comparison of SCO-encoded objects of arbitrary structure across a range of models and remote management endpoints. Further considerations may be directed to managing bandwidth and computation performances (CPU and memory utilization, query optimization, etc.) associated with uploading, storing, tracking, and processing large volumes of data to multiple endpoints. Moreover, various systems may be used for tagging and a skills assessment method to perform “gap analysis” to dynamically identify and map profiles to corresponding courses, as required to support development and testing activities related to the communication, versioning, and data-injection systems described above.

As such, the system 12 can be configured for delivering arbitrary SCO-encoded data, and to enable seamless telemetry-collection and analysis with this information independently of time-invariable, client-side environment version updates. To this end, techniques have been developed that enable data acquisition/manipulation regardless of arbitrary modifications at either end of the content delivery pipeline. Notably, a content handling mechanism can be used that dispatches session data and events into dedicated stage chunks that represent specific phases, attach data objects to relevant chunks, compute the corresponding encapsulation logic at each phase and asynchronously commit them to the network in an iterative process. In addition, techniques are incorporated to deliver arbitrary data authored and packaged by third-party tools with the objective to support special Unicode language scripts and characters.

In addition, techniques to compute diffs and version data objects independent of the browser, document, container, or environment generating these data are proposed. Specifically, a time-tracking mechanism allows diff computation of modifications affecting the edited content. The mechanism guarantees data tracking in a branching hierarchy by measuring the distance between each changeset of data object and subsequently applies a deletion and node integrity verification algorithm that is encapsulated and abstracted for each type of content type (Slide, Video, Quiz). This can improve the system's ability to achieve piecemeal and incremental updating of these SCOs, especially as it pertains to context-dependent application of updates to content.

The injection of SCO data into remote endpoints presents additional obstacles in that the acquisition layer is composed of independent LMSs 14 that individually encapsulate the ingestion logic for input data (e.g. evaluation score, course evolution, etc.), resulting in siloed environments that generate unpredictable, adverse interactions between the system's own injection software, and the SCO sources the system 12 encodes and injects into. These issues present technological uncertainties regarding the design of a mechanism that achieves consistent SCO delivery regardless of the content or the behavior of the source/presentation SCO in regard to parsing, structuring, & rendering. Encapsulation and communication methods capable of consistently delivering arbitrary, SCO-embedded data & instructions to these endpoints should be considered.

To improve the capacity to version and share discrete modular components/content of our encoded SCOs to multiple target objects presents an issue to seamlessly track/lineage and update nested data objects across non-hierarchical graph data structures, due to the fact that SCOs impose complex interdependence, integrity, and synchronisation requirements with regard to inheritance, translation, and management of data objects, which may interfere with the branching hierarchy of the SCO data management process. Lineage methods for data objects with arbitrarily complex inheritance and/or translation relationships may prevent adverse interactions between discrete content elements as managed by various data hosts, in order to maintain consistency in the rendering of our data streams.

To address issues related to the ability to consistently collect telemetry and interaction data from remotely rendered SCOs without requiring direct influence over the client-side rendering environment within an LMS host, one may identify injection issues across endpoints that ultimately caused missing progress and completion across the discrete LMS solutions. It has been found that intermittent and non-reproducible inconsistencies when executing API fetch operations with these remote endpoints may occur. It was found that those issues arose when users opened an additional browser tab from the original source tab, and deduced those issues arose from limitations at the data-ingestion layer, more specifically, that the system 12 was unable to embed at runtime the LMS data injection system during the creation of new tabs.

To address this, the system 12 could synchronize the data between the tabs and potentially launch the SCORM player to retrieve the information, however, it was found that the LMS 14 may only support links to the course launcher and may not open the SCORM player directly, making this option undesirable. Alternatively, one may synchronize learner ID information and related metadata between tabs, however, when a new tab is opened, the learner ID may not available. Further, one may transmit the learner ID from the SCORM player tab to the new tab using a get parameter on tab load but the system 12 may be unable to update progress and other information from the new tab back to the SCORM player tab, which is important for updating information in the LMS 14. Therefore, it was determined that launching the SCORM player independently in the application was not feasible due to the dependency on the LMS for information retrieval.

To address the issues above, one may persist the relevant data with either a new progress value through cookies, or local storage (cache) so that the tab with the SCORM player would then poll the cookie/cache to read the latest progress and commit it to the LMS 14. Synchronization issues between the tabs may occur, especially when users could use multiple tabs simultaneously to make progress in the course, if there is not an ability to coordinate progress updates across multiple tabs due to the isolation of the discrete tabs (code running in one tab could not directly access all the variables, functions, or data of another tab), and the lack of synchronization mechanisms when multiple tabs attempt to update the data simultaneously.

Concurrently with the above, the system 12 may be configured to improve its capacity to version and share discrete modular components/content of the encoded SCOs 72, both to allow multiple separate SCOs 72 to share a single piece of content, as well as to allow automatic 1:N (i.e. one to many) mappings between a single piece of content and multiple target objects, as to provide dynamic updates response to changes to the master/source (e.g. such as procedural updates to multi-language translations). A notable obstacle may be introduced, to maintain data consistency when dealing with discrete modular components that are being assembled and reassembled across different languages, and across topologically complex non-hierarchical structures, as this complicates an efficient, and accurate lineage/versioning determination, as (1) chain of translation can lead to loss of accuracy and clarity, (2) changes to one part of the structure might have cascading effects, and (3) in non-hierarchical structures, querying relationships may require traversing a large number of nodes, severely impacting performance, especially when handling entities with a large number of connections and interactions.

To this end, software methods may be employed to efficiently and accurately track/lineage modular pieces of our encoded SCOs 72 using prospective graph data models to represent the complex relationships between entities, such as Directed Acyclic Graph structure to prevent cycling when tracing the lineage, and versioned graphs to trace the evolution of content over time. Candidate metadata systems may also be used alongside unique identifiers to improve the system's capacity to manage complex nonlinear directional relationships. It has been found that complex sets of relationships and inheritance conditions related to the non-hierarchical data structure may exist, and issues when querying complex relationships with a large number of nodes can arise. To address this, a process for attribute inheritance has been developed, where certain metadata attributes can be inherited by translated or derived content and a set of query techniques were created with discrete traversal paths/strategies, join strategies, and depth-limiting algorithms. These techniques can efficiently parse and retrieve data throughout the complex non-hierarchical graph topology, as to determine data lineage/versioning when handling arbitrarily complex mappings between a single piece of content and multiple target objects, as well as related transitive relationships.

In summary, techniques to lineage methods for data objects with arbitrarily complex inheritance and/or translation relationships with the capacity to version and share discrete modular components/content of our encoded SCOs, both to allow multiple separate SCOs to share a single piece of content, as well as to allow automatic 1:N (i.e. one to many) mappings between a single piece of content and multiple target objects has been developed using a graph data model to represent the complex relationships between entities, alongside a metadata system with unique identifiers to improve our capacity to manage complex nonlinear directional relationships. A process for attribute inheritance, where certain metadata attributes can be inherited by translated or derived content, as well as a set of query techniques with discrete traversal paths/strategies, join strategies, and depth-limiting algorithms to efficiently parse and retrieve data throughout our complex non-hierarchical graph topology has also been configured for the system 12.

### Leveraging AI to Generate Courses

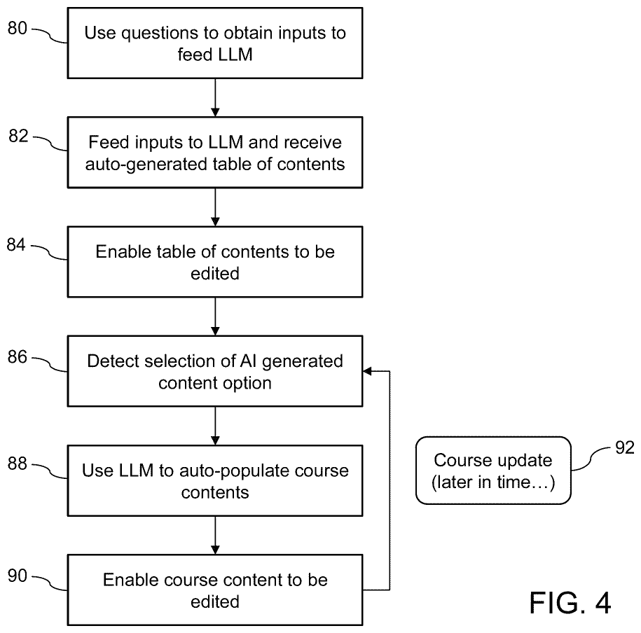

Referring now to FIG. 4, a process is illustrated that may be implemented by the system 12 in leveraging the LLM 22 to provide at least some automation into the course generation process. For example, the system 12 may access an LLM such as ChatGPT4 currently or later versions thereof or similar LLMs 22 as they become available. ChatGPT4 or another LLM 22 may be used to allow course authors to answer a few simple questions such as course title, length, level (e.g., beginner vs. advanced, etc.). At block 80, the AI module 42 may present the user with such questions, e.g., by being called by the server application 34 and sent to the user via the client device application 64 to obtain inputs to feed the LLM 22. The questions provide a way to obtain a preliminary structure for generating a prompt for the LLM 22. The preliminary structure and its questions may be predetermined or can be created in real time based on the context, e.g., the associated LMS 14, the industry, the user or user type, or other metadata that can be extracted from or by the client device 18 to seed the prompt generation process.

At block 82, the AI module 42, using the LLM interface 44, feeds the inputs (e.g., by way of a prepared prompt) to the LLM 22 and receives an auto-generated table of contents for the corresponding course. The LLM 22 would generate the table of contents, which may include lectures, topics, and slide titles to display to the author. At block 84, the table of contents is provided to the author and they are able to edit them. For example, the author can delete or add a lecture, topic or slide title to ensure that the course meets their expectations, requirements, etc. This first pass using the LLM 22 can be used to determine a set of categories, stages, sub-processes or other modules, chapters or divisions of the topic or process being documented in the course. The LLM 22 may have access to other contextual data to assist in aligning the prompt inputs with the desired course structure, allowing the user to, with only minimal information, obtain the first pass at the high level structure, which may then be populated as discussed below.

At block 86, an option can be selected by the author to automatically generate content using the AI module 42. The author can apply this option to specific topics or slides or to the entire table of contents. In this way, the AI module 42 can be called to again access an LLM 22 via the LLM interface 44 and populate text, audio, etc. in a selected language at block 88. The AI-generated course may then be displayed to the author in the same format as any other course created using the system 12. That is, the AI-generated content may be used to populate any portion of a course as if the user had authored it personally, with the ability to modify, edit, discard, augment or otherwise refine the AI-generated content in multiple passes. At block 90 the system 12 may enable the course content to be edited, deleted, or supplemented with video or other text, audio, etc. In addition, more content can be added to the course at any time, either currently when generating the course, or later after the course has been deployed and used. Any such additions or revisions can again utilize the AI module 42, e.g., to update/refresh content, etc. The same editing processes shown in FIG. 4 can be utilized and the AI module 42 can cause the course to be updated not only locally but changes to be pushed out to any user that has downloaded and begun using the course (e.g., as a course update similar to an app update). To enable such additions or revisions, the system 12 can store a centralized version of the current content, once published, such that when any changes are made, records indicative of who has used the course can be used to push out the changes in real-time thus allowing any user in any LMS 14 to continually be updated by the system 12.

At block 92, the system 12 can provide mechanisms to control the updating of content over time. For example, if content is added later (e.g., 1 or 2 years after being originally authored), the AI module 42 can remember the context of the course so that the content that is being added to the course (whether at the beginning, middle or end) will remain with the same flow, avoid repetition, and be in line with the rest of the course for consistency.

While not shown in FIG. 4, it can be appreciated that in the background, the AI-related modules, models, and tools can be trained. For example, a current catalogue of courses created manually may be used to initially train the LLM 22 for the authoring process (e.g., to match word counts, layout, flow, etc.) and to continually train the LLM 22 as more authors create content and edit the content using the system 12. That is, the AI module 42 can be used to track what authors do or do not like in a course as well as collect feedback from users and administrators, to continue to get better at automatically generating courses and content therefor.

As noted above, in one example, ChatGPT may be used as a publicly-available LLM 22. Because GPT-type language models tend to have a large number of parameters, these language models may be considered LLMs. An example GPT-type LLM is GPT-4. GPT-4 is a type of GPT language model that has been trained (in an unsupervised manner) on a large corpus derived from documents available to the public online. GPT-4 has a very large number of learned parameters (on the order of hundreds of billions), is able to accept a large number of tokens as input (e.g., up to 2048 input tokens), and is able to generate a large number of tokens as output (e.g., up to 2048 tokens). GPT-4 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

As discussed above, the system 12 may access a remote language model (e.g., a cloud-based language model), such as ChatGPT or GPT-4, via a software interface (e.g., an application programming interface (API) such as the LLM interface 44). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM 22 may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM 22 may be referred to as a prompt, which is a natural language input that includes instructions to the LLM 22 to generate a desired output. A computing system may generate a prompt that is provided as input to the LLM 22 via its API 44. As described above, the prompt may optionally be processed or pre-processed into a token sequence prior to being provided as input to the LLM 22 via its API 44. A prompt can include one or more examples of the desired output, which provides the LLM 22 with additional information to enable the LLM 22 to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

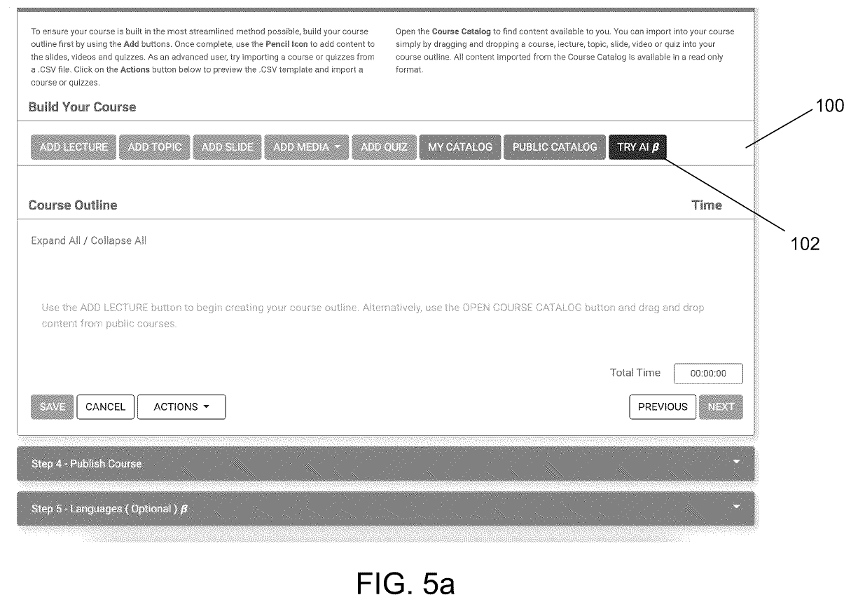

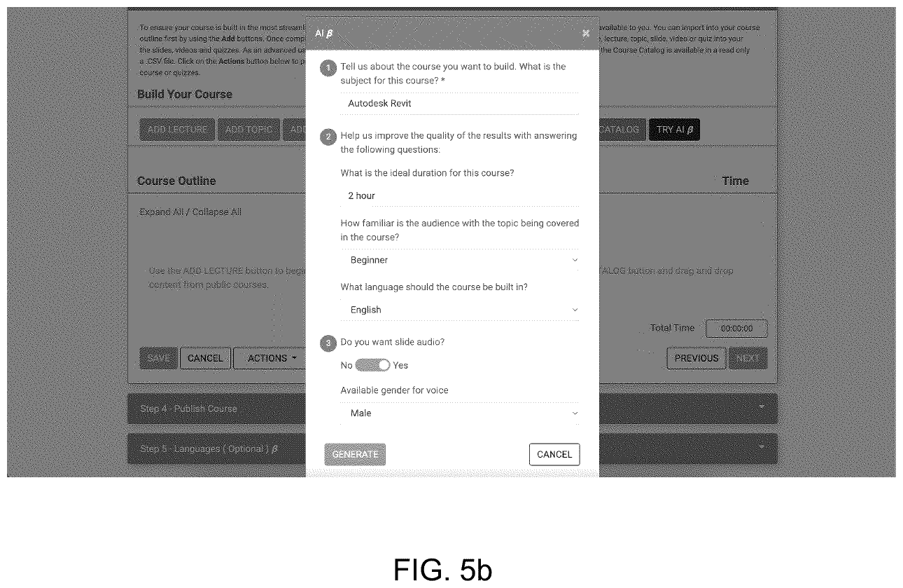

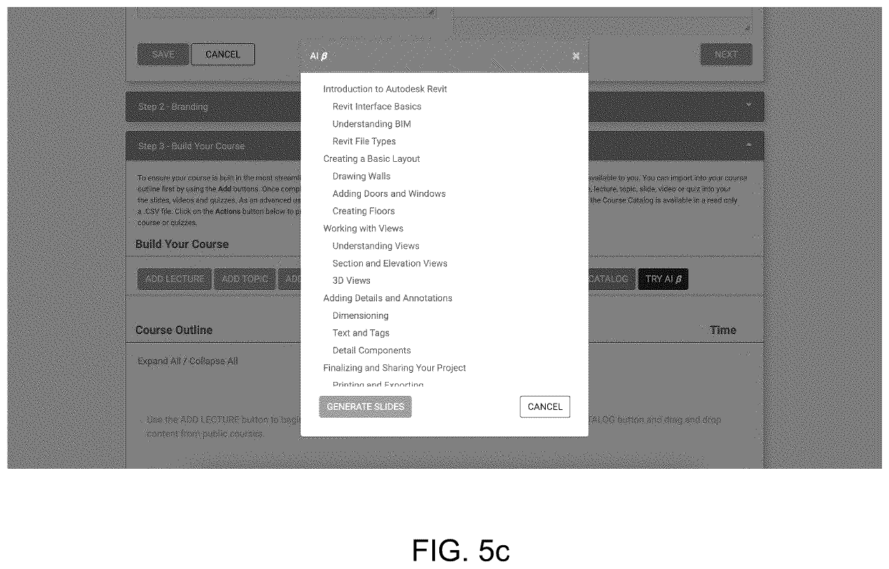

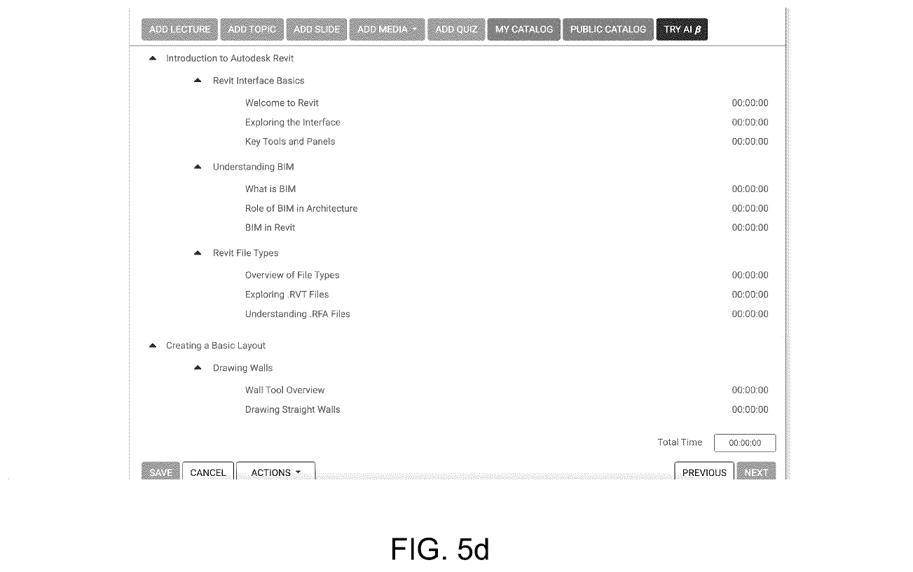

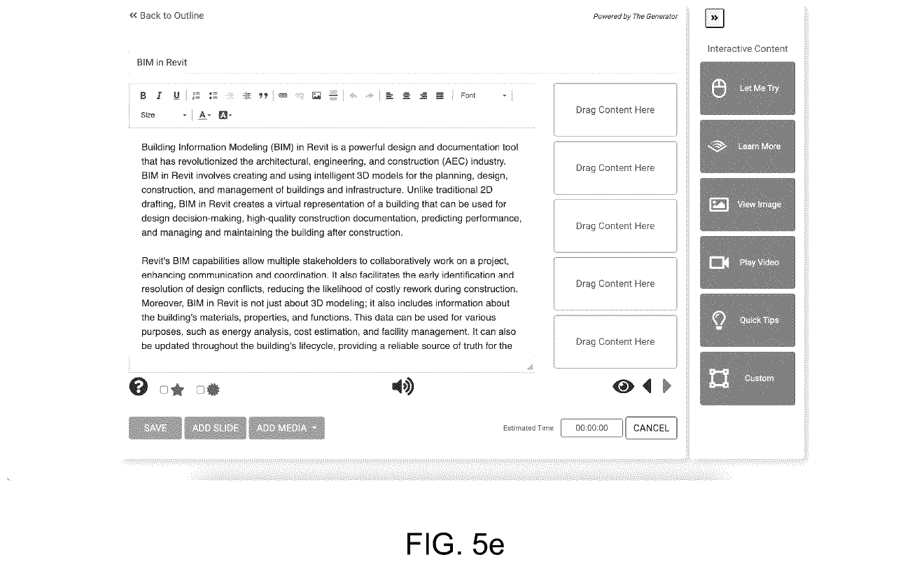

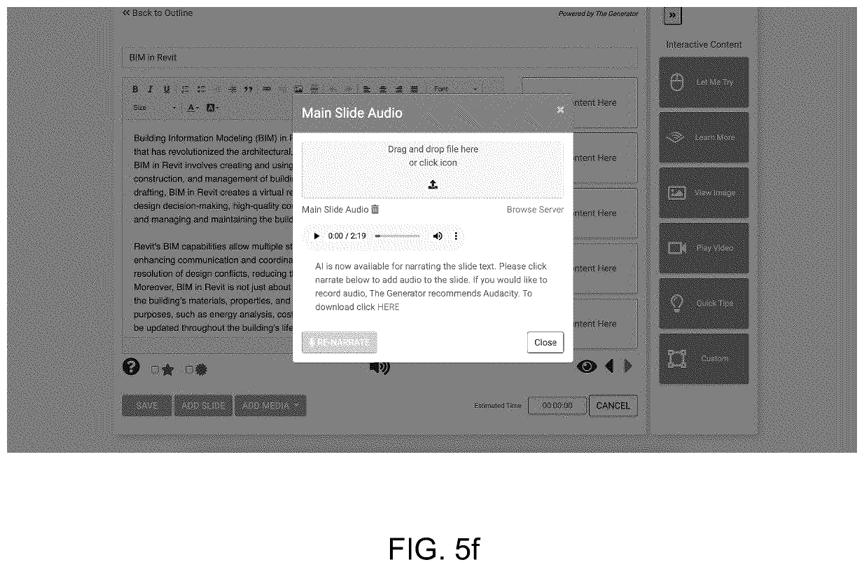

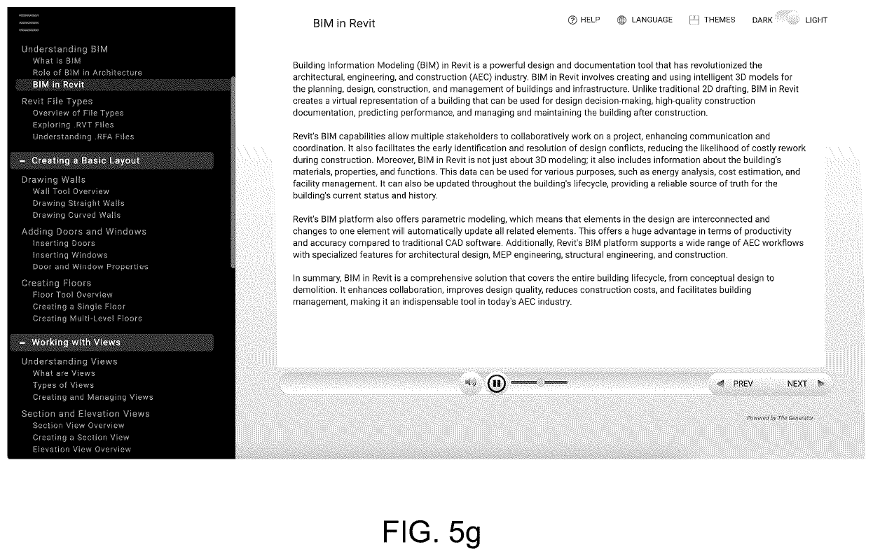

FIGS. 5-10 illustrate an example using the AI module 42 and LLM 22 to generate a course and its content. Referring first to FIGS. 5a through 5g, a course builder page 100 is shown, which provides an “Ask AI” option 102. The AI module 42 may then ask the author one or more questions as shown in FIG. 5b for ‘context’ and fine tuning ChatGPT response. For example, questions are optional except first: “Tell us about the course you want to build”. Also, “What is the subject for this course?” For example, the answers may include Revit Software, Baking cookies, Dog Grooming, etc. The AI module 42 can also ask the author to help the system 12 improve the quality of the results with answering the following questions: “What is the ideal duration for this course?” (example answers: 1 Hr, Less than 5 Hrs, About 4 hrs), and/or “How familiar is the audience with the topic being covered in the course?” (example answers: beginner, intermediate, advanced, general, etc.), and/or “What language should the course be built in?” (example answers: English, French). As noted above, the answers are used as inputs to the LLM 22. Limits may be placed by the system 12 and/or author, e.g., a maximum number of lectures, maximum number of topics in each lecture, maximum or minimum number of slides in each topic, etc. FIG. 5c illustrates an example of a course outline that is presented to the author based on a response obtained from the LLM 22. Slides may then be generated from this prompt, which generates a skeleton for the course, as shown in FIG. 5d. The AI module 42 may be used to also generate content for individual topics and slides. An example of an introduction slide is shown in FIG. 5e, which includes text generated using the LLM 22 and is editable by the author. FIG. 5f illustrates audio being added to the slide and FIG. 5g illustrates an example of a published output.

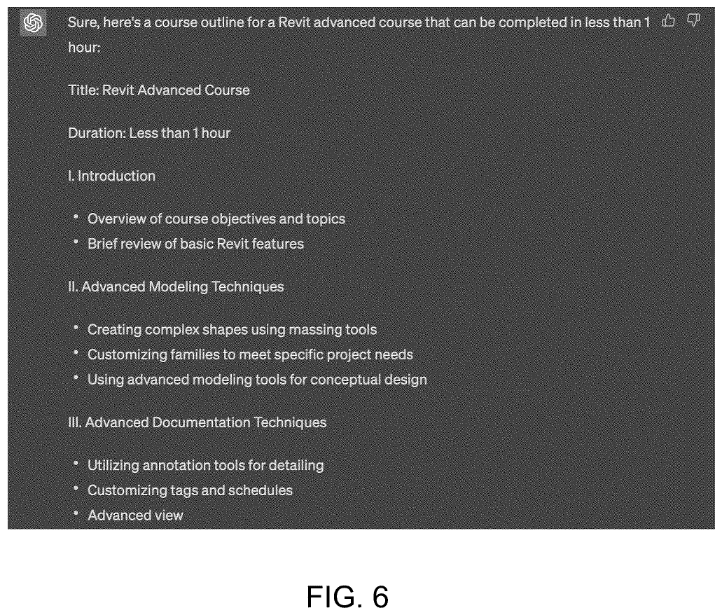

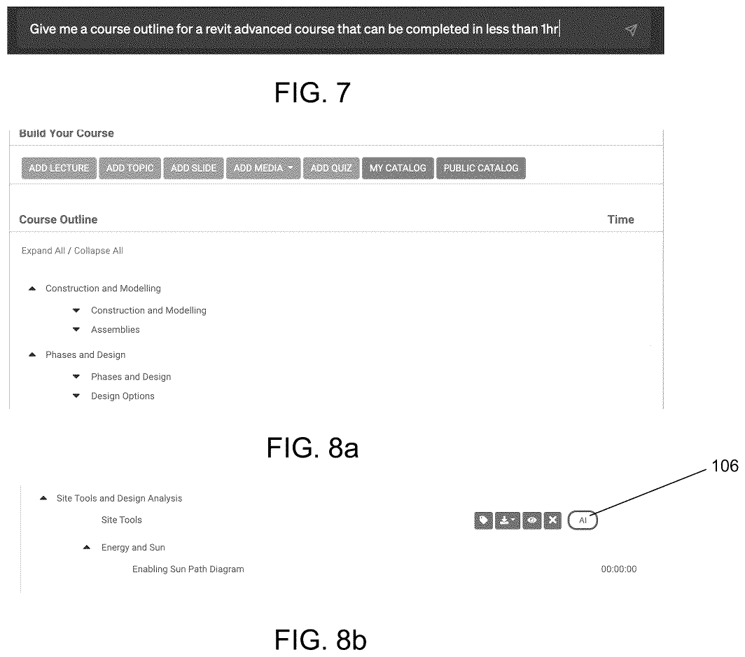

FIG. 6 illustrates a response provided by the LLM 22 (from the LLM's perspective) in return to these inputs. In this example, the course outline is generated based on another constraint, which can be provided by the author as shown in FIG. 7, namely the length of the course.

The response shown in FIG. 6 can be accepted and added to a course outline page as shown in FIG. 8a, similar to what is shown in FIG. 5d. As shown in FIG. 8b, the author can edit the outline. Once the outline (e.g., table of contents) is finalized, an AI option 106 may be presented and selected within each topic to enable the user to instruct the AI module 42 to have the LLM 22 generate content for that topic.

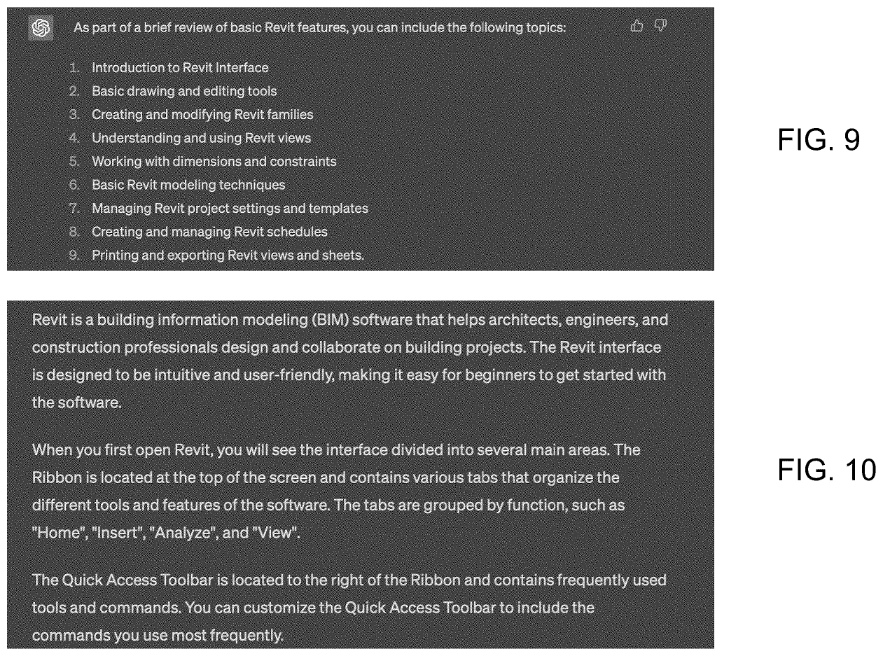

For example, when they click on AI option 106 at each topic, the system 12 can send to the LLM 22 the topic title, such as: “what can I include as part of Brief review of basic Revit features”. The LLM 22 comes back with one or more potential slides as illustrated in FIG. 9. Then, the system 12 can directly create the topics in the outline and also put the slide description in. The system 12 can ask the LLM 22 for the slide description by writing something like ‘write the content for “Introduction to Revit Interface.” An example response is shown in FIG. 10. Additionally, the system 12 can add ‘auto-generate’ the audio for the slides. The audio can give the author an option to choose from male/female voices and will read the slide description. The LLM 22 or other ML models may be accessed to source the audio, voices, etc.

### Translation Module

The course generator system 12 may include a translation module 46 as shown in FIG. 2. The translation module 46 allows users to author content in any language and allow others to drag and drop content from their courses into a new child course. One recognized technical challenge is that a course made up of content from multiple courses may not read well so it needs to be translated into a consistent language. However, to do this well the translation tools need to know what language the piece of content was authored in—otherwise the translation can deteriorate rapidly. This process can get further complicated when this child course gets used within a grandchild course and is blended with more languages. The system 12 avoids having a translation of a translation as this normally leads to a very poor-quality translation, so the translation tools need to look back to the original authored language to ensure nothing is double translated. The system 12 may impose warnings or errors when multiple languages are being combined into a course or page to enforce a set of rules, e.g., to ensure that the objects are translated into a consistent language, if necessary, e.g., by using the referential process described herein.

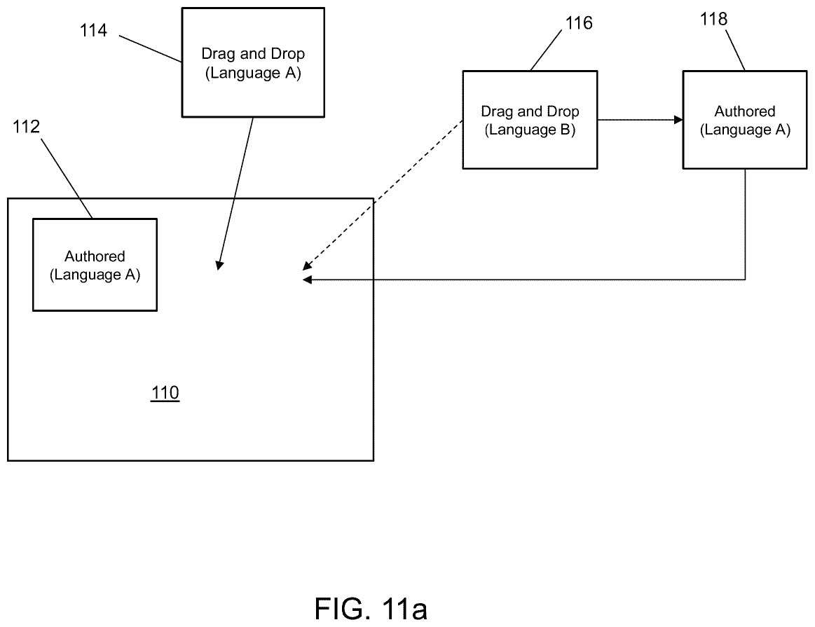

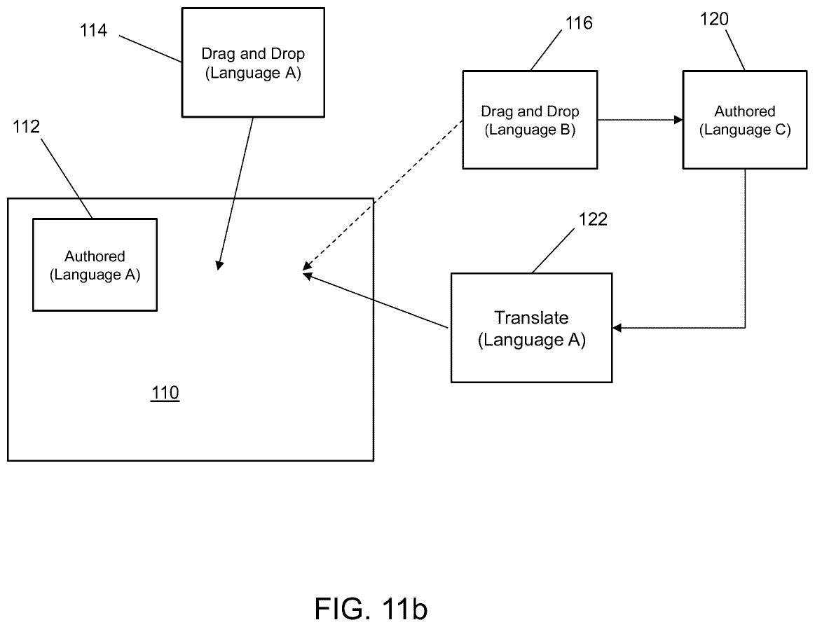

Referring now to FIGS. 11a and 11b, to maintain the consistency and quality of translated content, the system 12 may generate and store a referential data structure such as a table, graph, set of pointers, etc. that enables previous translations and thus available source content and direct translations therefrom to be referenced, accessed and utilized to avoid the propagation of errors. FIG. 11a illustrates a course page 110 with a first object 112 having been authored by a user in a first language, namely Language A, which is to be the common language for this course. In this example a second object 114 using Language A is dragged and/or dropped into another portion of the page 110. Since it also uses Language A, the “source” or “native” object is being utilized. However, for a third object 116, which is in Language B and thus not Language A, to avoid translating from Language B to Language A when it is determined that it was either already translated to Language A or, as shown here, was authored in Language A as a fourth object 118, the system 12 utilizes a saved link or pointer to find the authored version to add to the page 110. The third object 116 may have been chosen from another project that was itself authored in Language B or from a catalogue of content items that does not necessarily have a consistent language.

Referring now to FIG. 11b, in another example, it is determined that the third object 116 was authored in yet another language, namely Language C, a fifth object 120. To avoid making a translation of a translation, the source object in Language C is then translated to Language A to generate a sixth object 122 that may then be used in the page 110. It can be appreciated that the sixth object 122 may be stored and referenced for later use, e.g., if another author desires that content in Language A. The system 12 may manage the referential data using, for example, a table such as that shown below in Table 1:

TABLE 1
Example Referential Table

| | Authored | | | Translation |
|---|---|---|---|---|
| Object Name | Language | Shared | Source Link | Links |
| Blurb A | English | Y | link | Link a |
| | | | | Link b |
| | | | | Link c |
| Video B | French | Y | link | Link a |
| . . . | | | | |

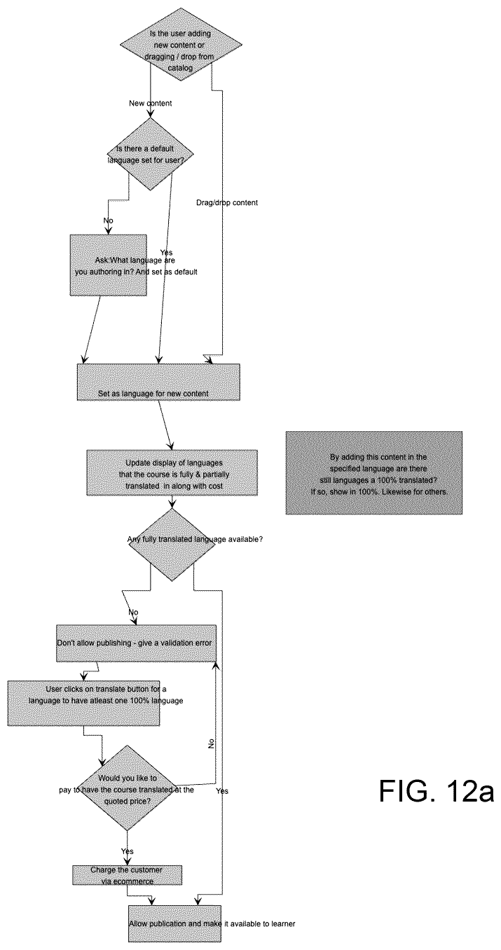

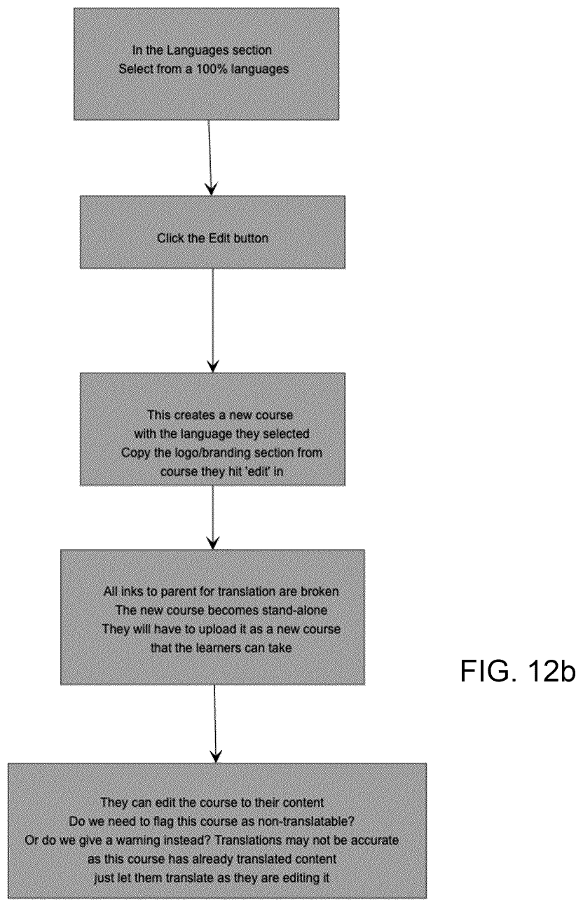

In addition to the challenges with managing content languages and the quality of translations, the system 12 should ensure that it is charging clients for this service and keeping costs to a minimum, so the system 12 may check for content that is already translated into the desired end language so that the system 12 or author does not pay twice to complete the same translation (of the same content), and therefore can keep costs to a minimum. Referring now to FIGS. 12a and 12b, example translation workflows are shown.

As shown in FIG. 12a, the translation module 46 can check to see if the user is adding new content or dragging/dropping from a catalog of content or courses. If it is new content, the translation module 46 determines if there is a default language set for the user. If not, the translation module 46 asks the user what language they are authoring in and may set that as a default. If there is a default language, this is set as the language for the new content. If the content is being dragged/dropped from another source, the language of that content may be set as the language for new content in this course.

Based on the new content and its language, a display of languages can be updated by the system 12 to indicate that the course is fully (and/or partially) translated into along with any costs associated with providing those language options. At this stage, the translation module 42 can determine if, by adding this content in the specified language, there are still languages that are one hundred percent translated. If so, the course can show “100%” for that content and likewise for other languages. At this stage, the operations shown in FIG. 12 may be implemented as discussed below. The translation module 46 determines if any fully translated languages are available (e.g., see FIG. 11a, 11b). If not, the course cannot yet be published and the user is given a validation error. If a fully translated language is available, the publication is allows and made available to the learners. When a validation error is triggered, the user can select a translate option for a selected language to ensure that the course is provided in at least one language in its entirety. The system 12 may then prompt the user with an option to have the course translated and can provided an estimated cost to do so. If the user declines the offer, the flow may return to the validation error. The user may then opt to obtain their own translation to rectify the error. If the user agrees to the quoted translation cost, the customer may be charged via their account and a translation initiated for the course and/or portion of the course.

Referring now to FIG. 12b, when a user selects from a 100% language they can select an edit button to create a new course with the language they selected. The logo/branding section can be copied from the course they are editing in. All links to the parent for translation are broken and the new course becomes stand-alone. The user would need to upload it as a new course that the users can take.

### Insights, Skills Gap Assessment, Quizzes

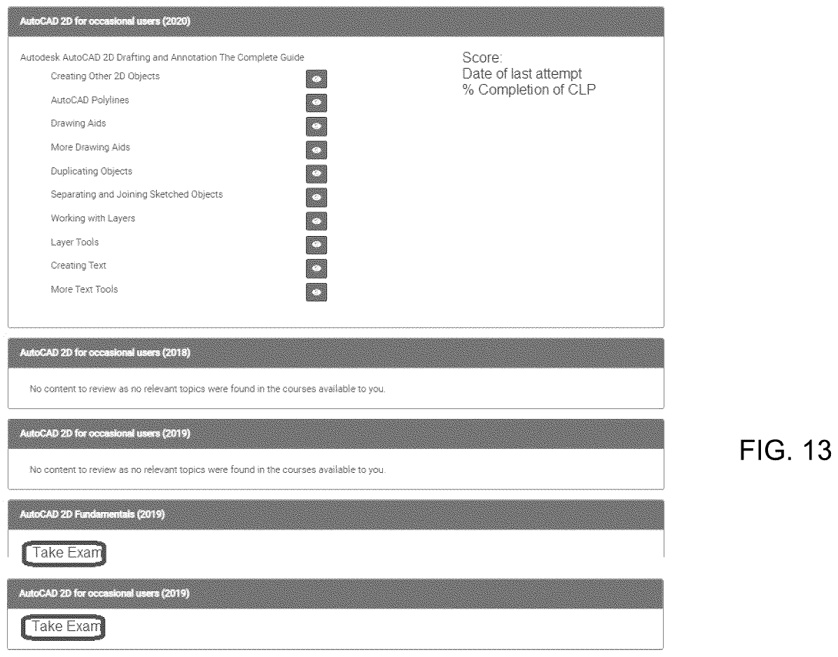

The insights module 48 provides a skills gap assessment tool. It is designed so that managers can use either pre-built exams, or build their own exams, assign them to staff or allow staff to assign the exams to themselves. They take the exam to receive feedback both for them, their manager and for a company to receive data and analytics about the skill sets and weakness within their organization. At the completion of an exam and learner can be provided with a custom course so they can take a tailored course geared to their weaknesses, they can be given a full report on what they got right and wrong and strengths and weaknesses. In addition, the exam can provide feedback to the learner. Managers and administrators can see a company-wide view of staff performance, from a named user to company-wide trends. FIGS. 13-31 illustrate such features.

Referring first to FIG. 13, a learner may select an option to initiate a gap assessment, which can display exam pages. As shown in FIG. 13, a list of assessments that are available to the learner can be shown. For any exams not taken, a “Take Exam” option can be displayed. Selecting this option launches the associated quiz. Once the learner takes the quiz, a CLP, score, date of the quiz attempt, and percent completion of the CLP can be shown.

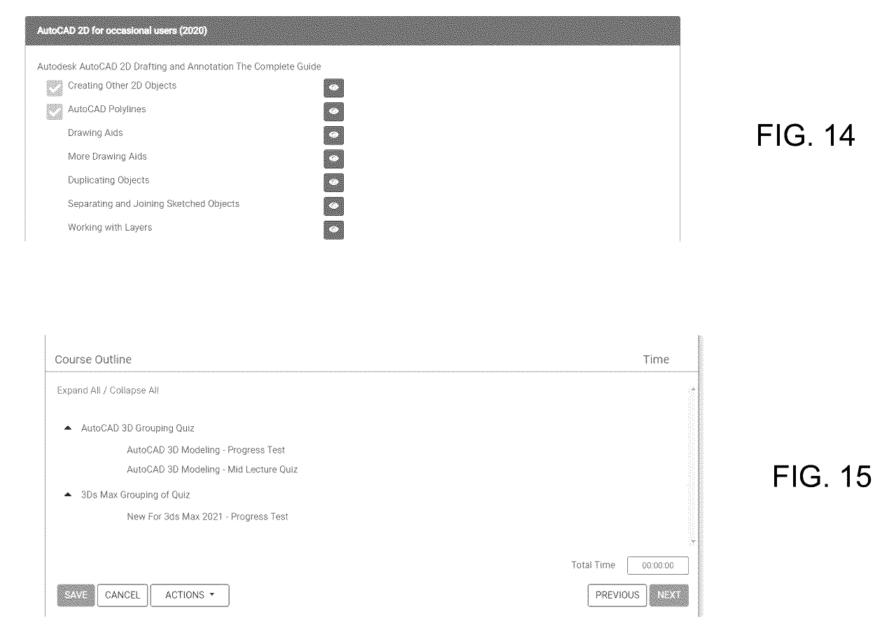

As shown in FIG. 14, checkmarks may be shown beside the content that the learner has already taken and the percent completion for the CLP is updated. An example of an assessment course is shown in FIG. 15. The assessments course includes a list of all quizzes that are available to the learner to assess themselves.

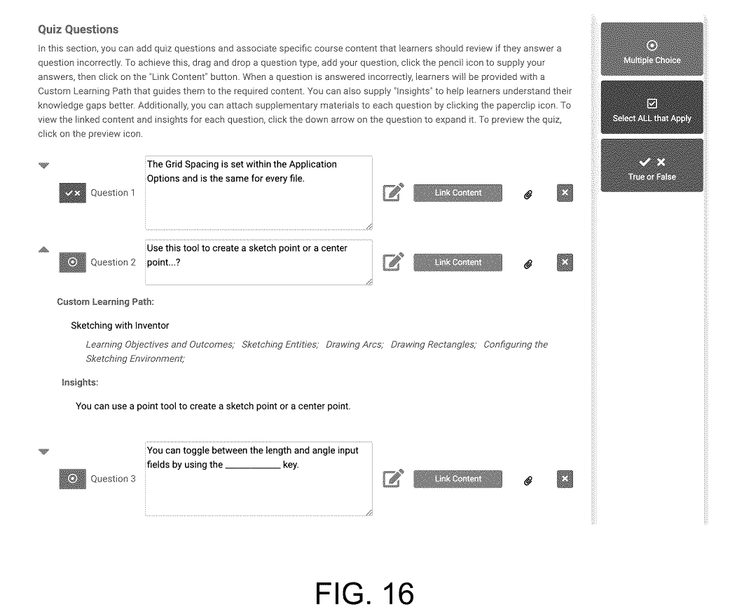

FIG. 16 illustrates a page for creating quiz questions. The system 12 can therefore design personalized quizzes that exclusively cater to an organization's learners. The quizzes provide the flexibility to craft a CLP that incorporates its own private courses as well as including relevant content from the public catalog. One can designate course content that the learners should review if they get a specific question in the quiz wrong and this content then becomes part of their CLP. For example, an organization can specify “Insights” for each questions that can help the learners address their knowledge gaps. There is the ability to control the visibility of the custom quizzes to the learners. There is also the ability to control the visibility of the insights quizzes to the learners. The administrator can choose to hide the quizzes from the organization's learners if they feel they are not relevant. A new report is available that shows question by question results. It also shows Insights for any questions that the learners got wrong. This allows the leaners to quickly review and address their knowledge gaps.

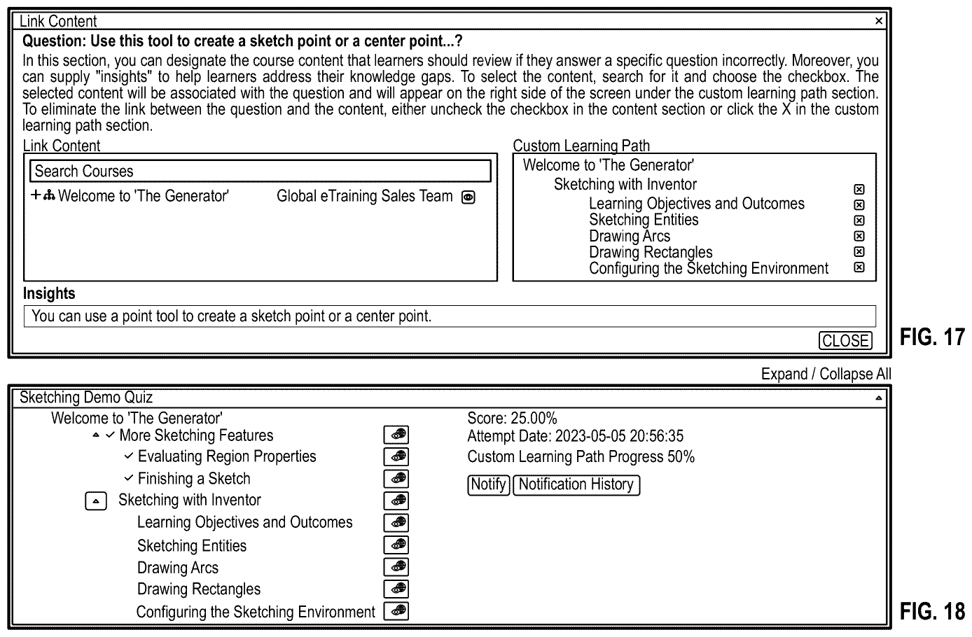

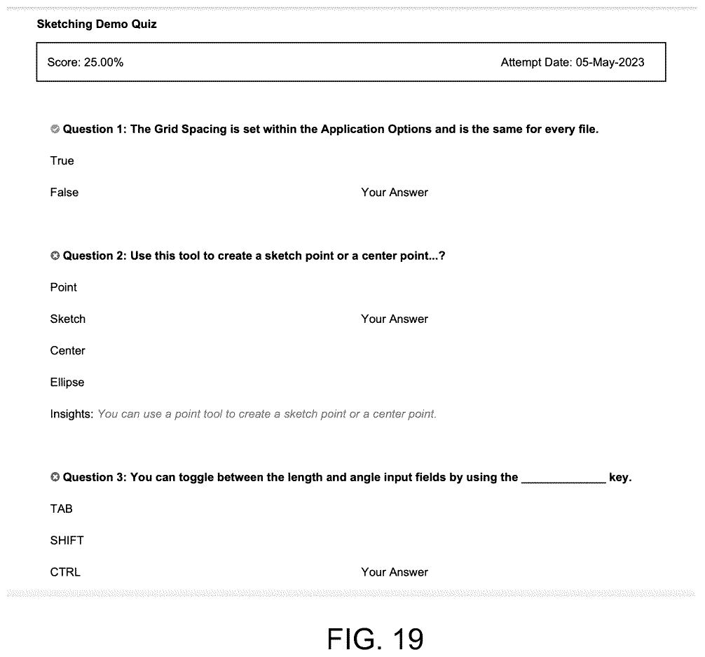

FIG. 17 illustrates a page to enable a CLP to be specified and insights to be obtained. A screenshot of a learner's page is shown in FIG. 18, with some progress shown by checkmarks. A report for an administrator is shown in FIG. 19.

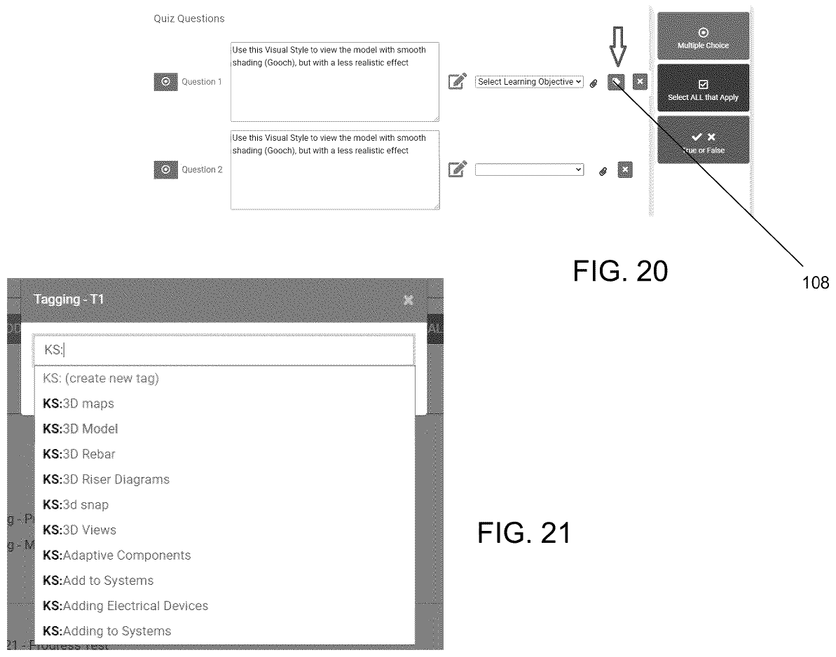

Each quiz question may need to be tagged. Referring to FIG. 20, a tag icon 108 can be added to each quiz question box. Selecting the tag icon 108 can initiate a tag window to be displayed as shown in FIG. 21. The course developer can then tag the question with relevant tags.

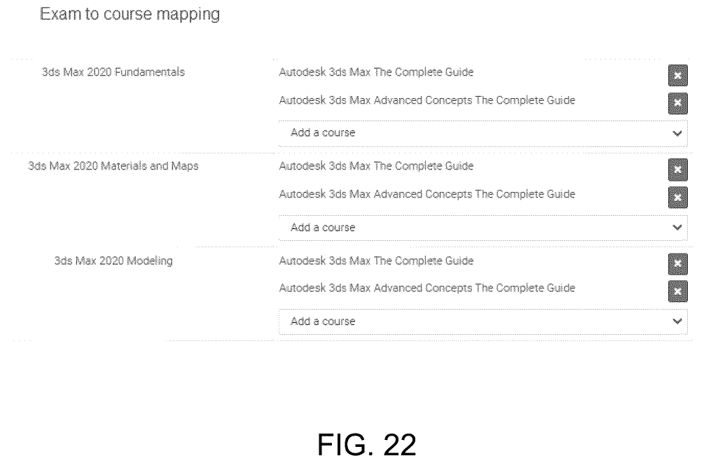

If the learner gets the question wrong in the quiz the system 12 can use the tags for the question to look up the content for the CLP using the course mapping illustrated in FIG. 22. That is, the system 12 can see which courses the quiz maps to and then search those courses for the tags of the question(s) they got wrong. And then use those topics to build their CLP.

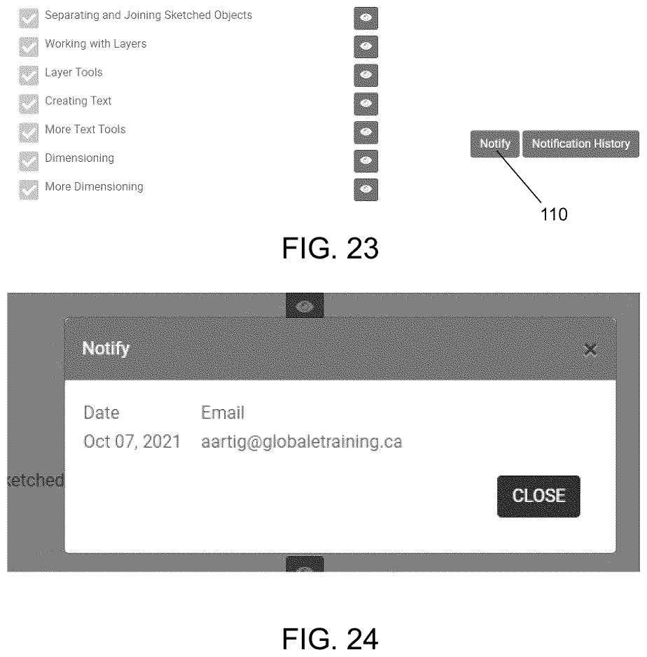

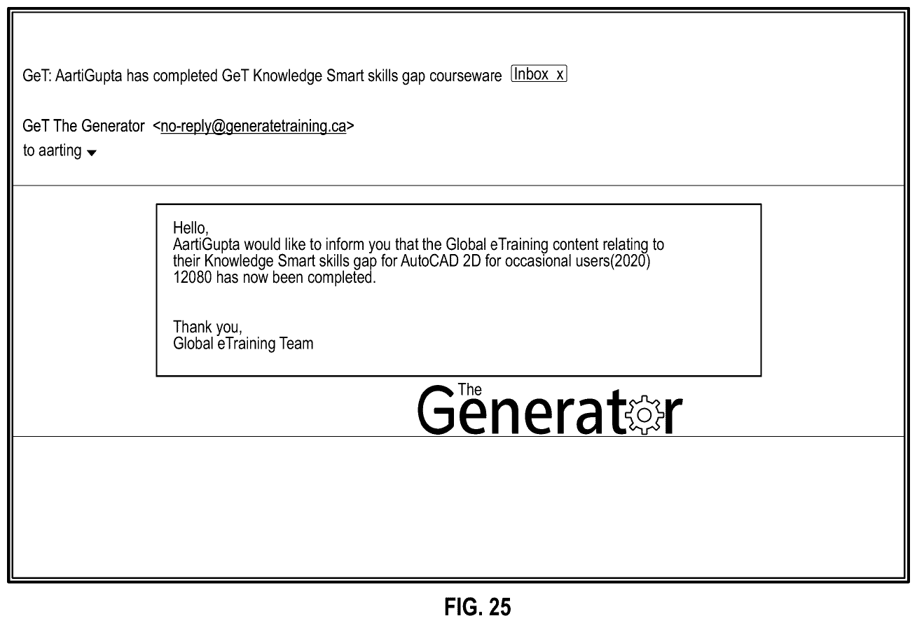

If the course developer updates the “assessment” course with a new/modified quiz and republishes, the new quiz or modified quiz should show in the main learner screen (see FIG. 13). If a quiz is deleted, the data should remain for any learners that have taken the quiz but the learners (who have not taken the quiz) should not see the deleted quiz in their list of quizzes the next time they login. The learner's manager can get insights into their results in various ways. For example, the type of reporting a manager may want to see can include the name of the learner, the exams they have taken, the score in each exam, which questions they got wrong in the exam—associated tags with that question, the percent completion of the learning path for that exam, etc. The system 12 can send a notification once all the CLP is completed, or could adapt this to show all the time instead of only upon completion of CLP. Then, the learner can send progress updates to their managers, e.g., by selecting a “Notify” option 110 as shown in FIG. 23 and enter the email of their admin as shown in FIG. 24. The email would contain the above reporting info and an example of a notification email is shown in FIG. 25.

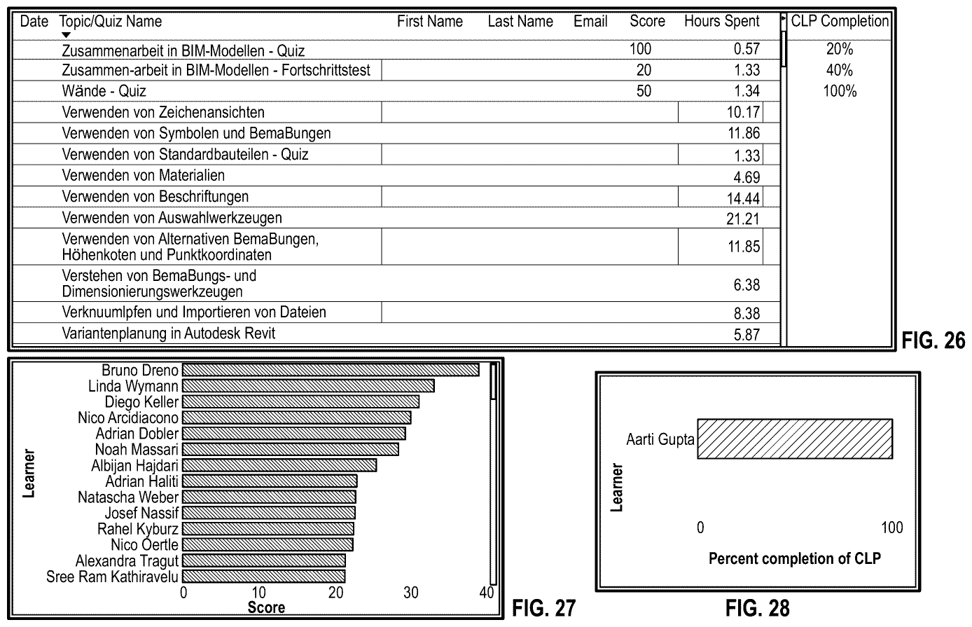

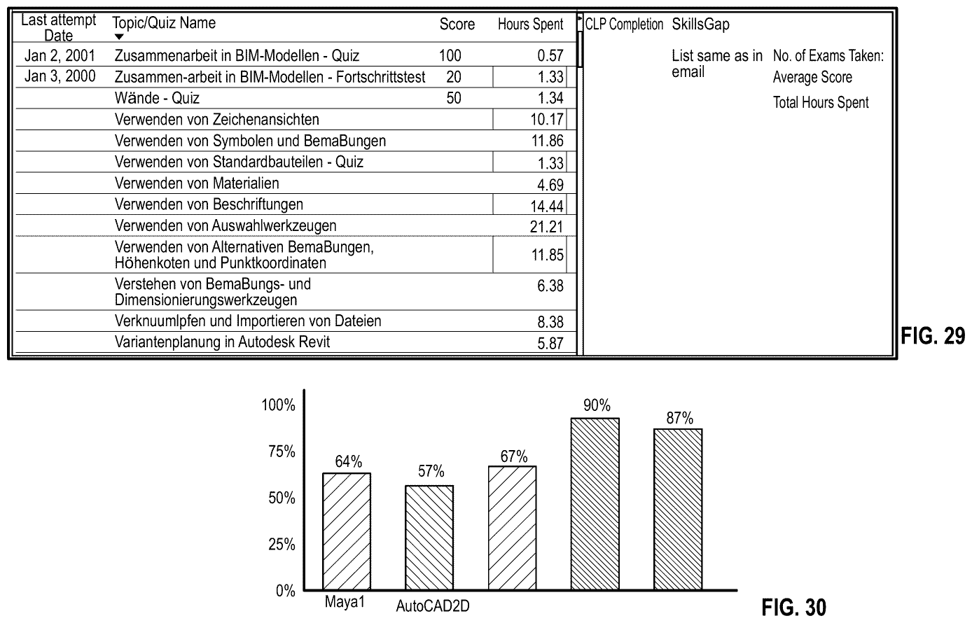

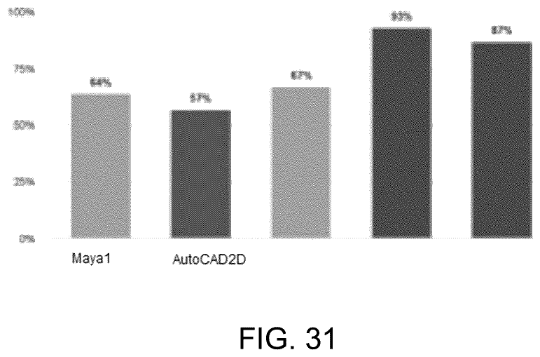

The system 12 can have two sections for the admin side reporting, for example, an exams section and a learner section. The table shown in FIG. 26 illustrates results for every exam, who took the exam, the date they took the exam, score, etc. Addition graphs can be provided, for example, the learners vs. score graph shown in FIG. 27 and the learners vs. CLP progress graph shown in FIG. 28. The learner section can provide a table such as that shown in FIG. 29, which shows all results for that learner. Additionally, for each learner, a quiz name versus score graph may be provided as shown in FIG. 30, as well as a quiz versus CLP completion graph as shown in FIG. 31.

The admin reports can be updated and delivered to administrators on a periodic basis, e.g., nightly.

### AIOS Module

The AIOS module 50 can provide a sub-system or platform within the environment 10 where all system applications can be accessed, as well as all customer applications can be accessed from one login. The AIOS module 50 can allow for user management, course management and data management pertaining to training. It addition, the AIOS module 50 can be set up to allow a large community of course authors to build content using the course generator system 12, publish these courses to any LMS 14 directly from AIOS module 50, see data on how their courses are performing from any LMS 14 and region, and enable them to have a trading platform for their content-so others can license the content from one or multiple course content providers, and depending on the licensing model with use the content as is for their own purposes- or repurpose the content into other content streams.

In this latter scenario, a recognized challenge may be if there is content used from a parent course, leveraged in a child course, then this content from the child course is then leveraged in a grandchild course. Here, the AIOS module 50 needs to be able to pay licensing monies and ensure IP protection to the author of the parent or the original content.

### Licensing Model

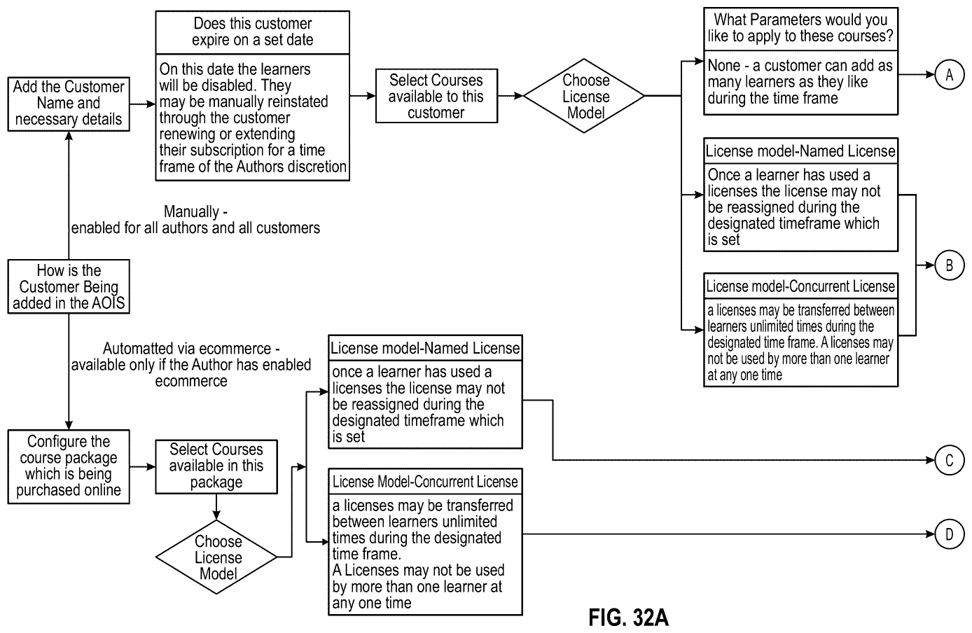

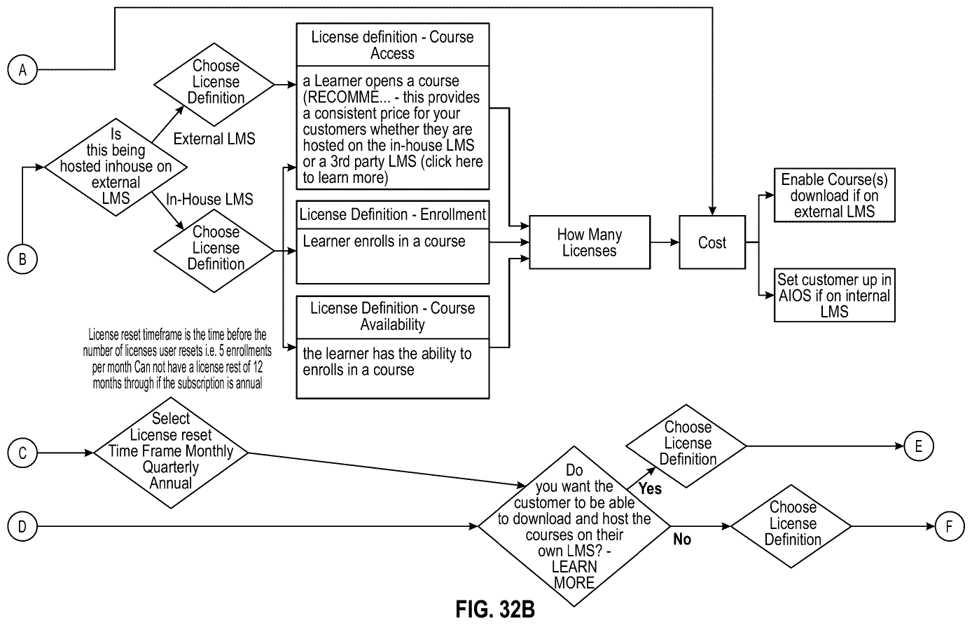

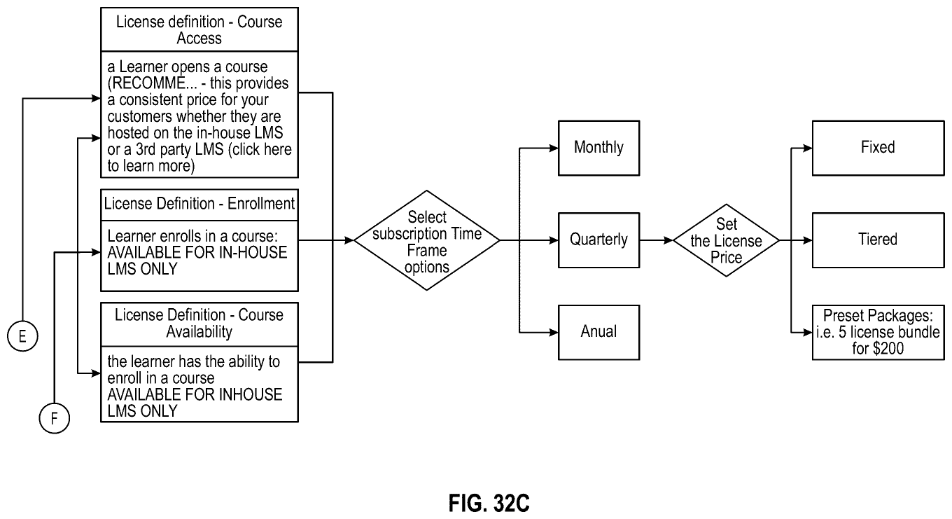

Referring now to FIGS. 32a, 32b, and 32c, a licensing model setup flow is shown.

The system 12 first determines now the customer is being added to the AIOS module 50. If manually, which is enabled for all authors and all customers, the top branch of the flow chart in FIGS. 32a-32c may be executed. Following the top branch first, the customer name and necessary details are added and the system 12 determines if that customer expires on a set date. On such a date, the learners will be disabled and they may be manually reinstated through a customer renewal process or by extending their subscription for a time frame of the author's discretion. The system 12 may then select the courses available to this customer and then choose a license model. Beginning at the top, the system 12 can ask what parameters should be applied to these courses. So, the license model is “none” (i.e., no parameters), meaning that a customer can add as many learners as they like during the time frame. A named license model may also be selected, which indicates that once a learner has used a license, the license may not be reassigned during the designated timeframe which has been set. A concurrent license model can also be selected wherein a license may be transferred between learners unlimited times during the designated timeframe. A license may not be used by more than one learner at one time.

Referring now to FIG. 32b while continuing the upper branch, with no parameters set, the flow moves to a cost box. For a named license or a concurrent license, the system 12 determines if the course is being hosted in-house or on an external LMS 14. If an external LMS 14, the system 12 chooses the license definition, in this case “course access”, which specifies that a learner opens a course to provide a consistent price for the customers whether they are on an in-house LMS 14 or 3^{rd} party external LMS 14. If hosting on an in-house LMS, other license definitions can be selected, such as enrollment where a learner enrolls in a course, or based on course availability, where the learner has the ability to enroll in a course. The license definition selection then leads to a “how many licenses” option, which leads to the cost stage. Referring also to FIG. 32c, the cost stage leads to enabling courses to be downloaded if on an external LMS 14 or to set the customer up in the AIOS module 50 if on an internal LMS 14.

Returning to FIG. 32a, the lower branch will now be described where a customer is added automatically to the AIOS module 50 via an ecommerce option (if the customer has enabled this option). The course package that is being purchased online can then be configured and the courses in this package are selected. The system 12 then determines the license model. This can be a named license or a concurrent license, which were described above. Referring now to FIG. 32b, for a named license, the license reset timeframe is the time before the number of licenses the user resets (e.g., 5 enrollments per month). The user can select the license reset timeframe (e.g., monthly, quarterly, annually, etc.). The system 12 then determines if the customer is able to download and host the courses on their own LMS 14. If yes, the license definition is chosen as course access as described above. If not, the license definition is either enrollment or course availability as described above. The subscription timeframe options are then selected, e.g., monthly, quarterly or annual as shown in FIG. 32c. The license price may then be set as fixed, tiered, or according to a present package.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method of generating electronic content, comprising:
obtaining, via a first user interface element, a first set of inputs responsive to one or more questions associated with an electronic course being authored;
using the first set of inputs to generate a first prompt to instruct a large language model (LLM) to generate a course outline;
providing the first prompt to the LLM;
receiving a first response from the LLM providing the course outline generated by the LLM based on the first set of inputs;
providing a second user interface element presenting at least one portion of the course outline;
enabling content to be generated for the at least one portion of the course outline, by generating at least one second prompt from the course outline or information associated with the at least one portion of the course outline;
providing the second prompt to an LLM; and
populating the at least one portion of the course outline using at least one second response from the LLM.

2. The method of claim 1, wherein an LLM is prompted a plurality of times, each time corresponding to a portion of the course outline to populate a plurality of course sections, chapters or slides.

3. The method of claim 1, further comprising enabling content added to the course to be edited.

4. The method of claim 3, wherein enabling the content added to the course to be edited comprises a further prompt to an LLM to refine the content.

5. The method of claim 1, further comprising publishing the course based on a final course outline and content added to each portion of the course outline.

6. The method of claim 1, further comprising:
storing the course in a centralized location;
permitting a plurality of learning management systems (LMSs) to access the course; and
responsive to a change or addition to the course recorded at the centralized location, pushing out updates to the plurality of LMSs to automatically synchronize content across all instances of the course.

7. The method of claim 1, wherein at least one of the first and second user interface elements is displayed responsive to an artificial intelligence option presented in a course generator application provided by a cloud-based course generator system.

8. The method of claim 1, further comprising providing a translation module to translate content to be added to the course to be translated to a desired language.

9. The method of claim 8, further comprising:
detecting that a first content object being added to the course is authored in a second language to be translated to a first language used by the course;
determining if the first content object is itself a translation of a second content object;
responsive to determining that the first content object is itself a translation, obtaining the second content object and utilizing it if using the first language or translating it from a third language to the first language.

10. The method of claim 9, wherein content objects previously used are stored with pointers or links thereto to create a network of available content objects to ensure objects are translated only a single time from an authored language.

11. The method of claim 8, further comprising tracking rights to content objects to apply licensing remuneration.

12. The method of claim 7, further comprising determining all translations required to populate the course in a desired language and prompting a user for payment of translation fees prior to publishing.

13. The method of claim 1, further comprising enabling collaboration by a plurality of users in generating and adding content to the course, and performing version control to avoid collisions.

14. The method of claim 5, wherein content is wrapped as a shareable content object (SCO) to enable hierarchical relationships, versioning, translation, and dynamic updates to the content on multiple learning management systems.

15. The method of claim 14, wherein the SCO is configured to enable reverse flow of data from the multiple learning management systems back to the system in a plurality of discrete data chunks.

16. The method of claim 15, wherein the discrete data chunks are lined up across the multiple learning management systems to enable aggregate data and information compiling when such multiple systems are not inherently built to align.

17. A computer readable medium comprising computer-executable instructions for generating electronic content, comprising instructions that, when executed by a processor of a computing system, cause the computing system to perform operations comprising:
obtaining, via a first user interface element, a first set of inputs responsive to one or more questions associated with an electronic course being authored;
using the first set of inputs to generate a first prompt to instruct a large language model (LLM) to generate a course outline;
providing the first prompt to the LLM;
receiving a first response from the LLM providing the course outline generated by the LLM based on the first set of inputs;
providing a second user interface element presenting at least one portion of the course outline;
enabling content to be generated for the at least one portion of the course outline, by generating at least one second prompt from the course outline or information associated with the at least one portion of the course outline;
providing the second prompt to an LLM; and
populating the at least one portion of the course outline using at least one second response from the LLM.

18. A computing system for generating electronic content, the system comprising:
at least one processor; and
at least one memory, the memory storing computer executable instructions that, when executed by the at least one processor, cause the computing system to perform operations comprising:
obtaining, via a first user interface element, a first set of inputs responsive to one or more questions associated with an electronic course being authored;
using the first set of inputs to generate a first prompt to instruct a large language model (LLM) to generate a course outline;
providing the first prompt to the LLM;
receiving a first response from the LLM providing the course outline generated by the LLM based on the first set of inputs;
providing a second user interface element presenting at least one portion of the course outline;
enabling content to be generated for the at least one portion of the course outline, by generating at least one second prompt from the course outline or information associated with the at least one portion of the course outline;
providing the second prompt to an LLM; and
populating the at least one portion of the course outline using at least one second response from the LLM.

19. The system of claim 18, further configured to perform operations comprising:
storing the course in a centralized location;
permitting a plurality of learning management systems (LMSs) to access the course; and
responsive to a change or addition to the course recorded at the centralized location, pushing out updates to the plurality of LMSs to automatically synchronize content across all instances of the course.

20. The system of claim 18, wherein at least one of the first and second user interface elements is displayed responsive to an artificial intelligence option presented in a course generator application provided by a cloud-based course generator system.
